(19) United States
(12) Patent Application Publication
(10) Pub. No.: US 2016/0002461 A1
(43) Pub. Date: Jan. 7, 2016

(54) COMPOSITION CONTAINING CELLULOSE AND DISPERSANT

(71) Applicants: DIC CORPORATION, Tokyo (JP); KYOTO UNIVERSITY, Kyoto-shi (JP)

(72) Inventors: Yoshinobu Tsujii, Uji-shi (JP); Keita Sakakibara, Uji-shi (JP); Taiyo Aoyagi, Uji-shi (JP); Hiroyuki Yano, Uji-shi (JP)

(21) Appl. No.: 14/770,556

(22) PCT Filed: Feb. 26, 2014
(86) PCT No.: PCT/JP2014/054720

§ 371 Date: Aug. 26, 2015

(30) Foreign Application Priority Data
Feb. 26, 2013 (JP) 2013-036494

(51) Int. Cl. C08L 53/00; C08L 101/00; C08F 293/00; C08L 1/02

(52) U.S. Cl. CPC C08L 53/00; C08L 1/02; C08L 101/00; C08F 293/00; C08L 2205/03; C08L 2310/00; C08L 2205/035; C08L 2205/16

(57) ABSTRACT

The present invention provides a composition comprising cellulose and a dispersant, the composition being capable of improving the dispersibility of cellulose in resin. More specifically, the present invention provides a composition comprising cellulose and a dispersant, the dispersant comprising a resin affinity segment A and a cellulose affinity segment B and having a block copolymer structure or gradient copolymer structure.

### TECHNICAL FIELD

The present invention relates to a composition comprising cellulose and a dispersant.

### BACKGROUND ART

Cellulose fibers are a basic skeletal material of all plants, and more than one trillion tons of cellulose fibers are amassed on the earth. Cellulose fibers are one-fifth as light as steel but are five times stronger than steel, with a linear thermal expansion coefficient as low as 1/50 that of glass.

Incorporating cellulose fibers as a filler in a matrix such as resin is a known technique to impart mechanical strength (Patent Literature (PTL) 1). To further improve the mechanical strength obtained with the use of cellulose fibers, cellulose nanofibers (CNF, microfibrils of plant fibers) are produced from cellulose fibers through defibration (Patent Literature (PTL) 2).

Cellulose nanocrystals (CNC) are also known to be obtained from cellulose fibers through defibration, as with CNF. CNF refers to fibers obtained by subjecting cellulose fibers to mechanical defibration, etc. CNF has a fiber width of about 4 to 100 nm and a fiber length of about 5 μm or more. CNC refers to crystals obtained by subjecting cellulose fibers to a chemical treatment, such as acid hydrolysis. CNC has a crystal width of about 10 to 50 nm and a crystal length of about 500 nm. CNF and CNC are collectively referred to as “nanocellulose.” Nanocellulose has a high specific surface area (250 to 300 m²/g), and is lighter and stronger than steel.

Nanocellulose is less subject to thermal deformation than glass. Nanocellulose, which has high strength and low thermal expansion, is useful as a sustainable resource material. For example, the following materials have been developed and produced: composite materials with high strength and low thermal expansion obtained by combining nanocellulose with polymeric materials such as resin; aerogel materials; optical anisotropy materials using CNC self-assembly driven by a chiral nematic liquid crystal phase; and advanced functional materials obtained by introducing functional groups into nanocellulose.

Since nanocellulose is hydrophilic and strongly polar due to an abundance of hydroxyl groups, nanocellulose is less compatible with generally used, hydrophobic, and non-polar resins.

In material development using nanocellulose, chemical treatment, such as surface modification of nanocellulose or introduction of functional groups into nanocellulose, has been considered to improve the compatibility of nanocellulose with generally used resins. In other words, improving the dispersibility of nanocellulose in a generally used resin has been considered.

The addition of a dispersant to a composition comprising cellulose fibers and a generally used resin has also been considered to improve the compatibility of cellulose fibers with a generally used resin. In Patent Literature (PTL) 3, a resin composition comprising cellulose fibers and a thermoplastic resin is mixed with, for example, inorganic substances, such as carbon black and zinc oxide, and dispersants, such as a polyol, a castor oil hydrogenated product, and a ricinoleic acid derivative, to disperse the cellulose fibers in the thermoplastic resin.

In Non-patent Literature 1, a surfactant is caused to adsorb onto cellulose nanocrystals (cellulose nanowhisker) to improve the dispersibility of the cellulose nanocrystals in an organic solvent. In Non-patent Literature 2, an isotactic polypropylene composite is produced by using surfactant-adsorbed cellulose nanocrystals as a reinforcement material. This isotactic polypropylene composite has a 1.4 times higher tensile strength than iPP alone.

Patent Literature (PTL) 4 discloses that when cellulose is used as a reinforcement material for a thermoplastic resin, cellulose fibers are dispersed, together with a hydrophilic additive having a specific HLB (hydrophile-lipophile balance) value (a low-molecular surfactant), to thereby prevent aggregation of cellulose and uniformly disperse the cellulose in the resin.

However, known components used as a dispersant were unable to form a strong interaction with cellulose fibers to achieve heat stability and impact stability, or known components used as dispersants were unable to achieve sufficient compatibility or affinity between cellulose fibers and a resin.

Therefore, there is still room for preventing the formation of cellulose aggregation in a resin and improving insufficient strength at the interface between cellulose fibers and a resin.

### CITATION LIST

### Patent Literature

PTL 1: JP2008-266630A
PTL 2: JP2011-213754A
PTL 3: JP2012-201767A
PTL 4: WO 2012/111408A1

### Non-Patent Literature

Non-patent Literature 1: Heux et al., Langmuir, Vol. 16, No. 21, 2000, 8210-8212
Non-patent Literature 2: Ljungberg et al., Polymer, Vol. 47, 2006, 6285-6292

### SUMMARY OF INVENTION

### Technical Problem

An object of the present invention is to provide a composition comprising cellulose and a dispersant, the composition being capable of improving the dispersibility of the cellulose in a resin.

### Solution to Problem

The present inventors conducted extensive research to achieve the above object and found that the use of a composition comprising cellulose and a dispersant, the dispersant comprising a resin affinity segment A and a cellulose affinity segment B and having a block copolymer structure or a gradient copolymer structure, improves the dispersibility of the cellulose in a resin.

Based on the above findings, the present inventors further conducted extensive research. The present invention has thus been completed.

Item 1. A composition comprising cellulose and a dispersant, the dispersant comprising a resin affinity segment A and a cellulose affinity segment B and having a block copolymer structure or gradient copolymer structure.

Item 2. The composition according to Item 1,

wherein the cellulose is at least one member selected from the group consisting of cellulose nanofibers, microfibrillated cellulose, microcrystal cellulose (cellulose nanocrystals), pulp, lignocellulose, and wood flour.

Item 3. The composition according to Item 1 or 2,

wherein the resin affinity segment A has a number average molecular weight determined by gel permeation chromatography of 100 to 20,000 on a polystyrene basis, and the proportion of the resin affinity segment A in the entire dispersant is 5 to 95 mass %, and

wherein the cellulose affinity segment B has a number average molecular weight determined by gel permeation chromatography of 100 to 20,000 on a polystyrene basis, and the proportion of the cellulose affinity segment B in the entire dispersant is 5 to 95 mass %.

Item 4. The composition according to any one of Items 1 to 3,

wherein the dispersant has a number average molecular weight determined by gel permeation chromatography of 200 to 40,000 on a polystyrene basis, and a molecular weight distribution index (weight average molecular weight/number average molecular weight) of 1.0 to 1.6.

Item 5. A resin composition comprising a resin and a dispersant, the dispersant comprising a resin affinity segment A and a cellulose affinity segment B and having a block copolymer structure or a gradient copolymer structure.

Item 6. The resin composition according to Item 5, wherein the resin is a thermoplastic resin.

Item 7. A resin composite composition comprising cellulose, a resin, and a dispersant, the dispersant comprising a resin affinity segment A and a cellulose affinity segment B and having a block copolymer structure or a gradient copolymer structure.

Item 8. A resin molding material comprising the resin composite composition of Item 7.

Item 9. A resin molded article obtained by molding the resin molding material of Item 8.

Item 10. A dispersant comprising a resin affinity segment A and a cellulose affinity segment B and having a block copolymer structure or a gradient copolymer structure.

Item 11. The dispersant according to Item 10,

wherein the resin affinity segment A has a number average molecular weight determined by gel permeation chromatography of 100 to 20,000 on a polystyrene basis, and the proportion of the resin affinity segment A in the entire dispersant is 5 to 95 mass %, and

wherein the cellulose affinity segment B has a number average molecular weight determined by gel permeation chromatography of 100 to 20,000 on a polystyrene basis, and the proportion of the cellulose affinity segment B in the entire dispersant is 5 to 95 mass %.

Item 12. The dispersant according to Item 10 or 11,

wherein the dispersant has a number average molecular weight determined by gel permeation chromatography of 200 to 40,000 on a polystyrene basis, and a molecular weight distribution index (weight average molecular weight/number average molecular weight) of 1.0 to 1.6.

Item 13. The dispersant according to any one of Items 10 to 12,

wherein the resin affinity segment A is a segment containing a vinyl-based monomer unit, and the cellulose affinity segment B is a segment containing a vinyl-based monomer unit.

Item 14. The dispersant according to any one of Items 10 to 12,

wherein the resin affinity segment A is a segment containing at least one monomer unit selected from the group consisting of (meth)acrylate-based monomers, (meth)acrylamide-based monomers, and styrene-based monomers, and

wherein the cellulose affinity segment B is a segment containing at least one monomer unit selected from the group consisting of (meth)acrylate-based monomers, (meth)acrylamide-based monomers, and styrene-based monomers.

Item 15. A method for producing a resin composite composition, the method comprising the steps of:

(1) mixing cellulose and a dispersant to obtain a composition comprising the cellulose and the dispersant; and

(2) mixing a resin and the composition obtained in step (1),

wherein the dispersant comprises a resin affinity segment A and a cellulose affinity segment B and has a block copolymer structure or a gradient copolymer structure.

Item 16. A method for producing a resin composite composition, the method comprising the steps of:

(1) mixing cellulose and a dispersant to obtain a composition comprising the cellulose and the dispersant; and

(2) mixing a resin, a dispersant, and the composition obtained in step (1),

wherein the dispersant comprises a resin affinity segment A and a cellulose affinity segment B and has a block copolymer structure or a gradient copolymer structure.

Item 17. A method for producing a resin composite composition, the method comprising the steps of:

(1) mixing cellulose and a dispersant to obtain a composition comprising the cellulose and the dispersant;

(2) mixing a resin and a dispersant to obtain a resin composition comprising the resin and the dispersant; and

(3) mixing the composition obtained in step (1) and the resin composition obtained in step (2),

wherein the dispersant comprises a resin affinity segment A and a cellulose affinity segment B and has a block copolymer structure or a gradient copolymer structure.

Item 18. A method for producing a resin composite composition, the method comprising the steps of:

(1) mixing cellulose and a dispersant to obtain a composition comprising the cellulose and the dispersant;

(2) mixing a resin and a dispersant to obtain a resin composition comprising the resin and the dispersant; and

(3) mixing the composition obtained in step (1), the resin composition obtained in step (2), and a resin,

wherein the dispersant comprises a resin affinity segment A and a cellulose affinity segment B and has a block copolymer structure or a gradient copolymer structure.

Item 19. A method for producing a resin composite composition, the method comprising the steps of:

(1) mixing cellulose and a dispersant to obtain a composition comprising the cellulose and the dispersant;

(2) mixing a resin and a dispersant to obtain a resin composition comprising the resin and the dispersant; and

(3) mixing the composition obtained in step (1), the resin composition obtained in step (2), and a dispersant,

wherein the dispersant comprises a resin affinity segment A and a cellulose affinity segment B and has a block copolymer structure or a gradient copolymer structure.

Item 20. The method for producing a resin composite composition, the method comprising the steps of:

(1) mixing cellulose and a dispersant to obtain a composition comprising the cellulose and the dispersant;

(2) mixing a resin and a dispersant to obtain a resin composition comprising the resin and the dispersant;

(3) mixing the composition obtained in step (1), the resin composition obtained in step (2), a resin, and a dispersant,

wherein the dispersant comprises a resin affinity segment A and a cellulose affinity segment B and has a block copolymer structure or a gradient copolymer structure.

Item 21. A method for producing a resin composite composition, the method comprising the step of

(1) mixing cellulose, a resin, and a dispersant to obtain a resin composite composition,

wherein the dispersant comprises a resin affinity segment A and a cellulose affinity segment B and has a block copolymer structure or a gradient copolymer structure.

Item 22. A method for producing a resin composite composition, the method comprising the steps of:

(1) mixing a resin and a dispersant to obtain a resin composition comprising the resin and the dispersant; and

(2) mixing cellulose and the resin composition obtained in step (1),

wherein the dispersant comprises a resin affinity segment A and a cellulose affinity segment B and has a block copolymer structure or a gradient copolymer structure.

Item 23. A method for producing a resin composite composition, the method comprising the steps of:

(1) mixing a resin and a dispersant to obtain a resin composition comprising the resin and the dispersant; and

(2) mixing cellulose, a resin, and the resin composition obtained in (1),

wherein the dispersant comprises a resin affinity segment A and a cellulose affinity segment B and has a block copolymer structure or a gradient copolymer structure.

Item 24. A method for producing a resin composite composition, the method comprising the steps of:

(1) mixing a resin and a dispersant to obtain a resin composition comprising the resin and the dispersant; and

(2) mixing cellulose, a dispersant, and the resin composition obtained in step (1),

wherein the dispersant comprises a resin affinity segment A and a cellulose affinity segment B and has a block copolymer structure or a gradient copolymer structure.

Item 25. A method for producing a resin composite composition, the method comprising the steps of:

(1) mixing a resin and a dispersant to obtain a resin composition comprising the resin and the dispersant; and

(2) mixing cellulose, a resin, a dispersant, and the resin composition obtained in step (1),

wherein the dispersant comprises a resin affinity segment A and a cellulose affinity segment B and has a block copolymer structure or a gradient copolymer structure.

Item 26. A method for producing a resin composite composition,

the method comprising further mixing a resin with the resin composite composition obtained by using the production method of any one of Items 15 to 25,

wherein the dispersant comprises a resin affinity segment A and a cellulose affinity segment B and has a block copolymer structure or a gradient copolymer structure.

### Advantageous Effects of Invention

The composition of the present invention is capable of improving the dispersibility of cellulose in a resin.

### BRIEF DESCRIPTION OF DRAWINGS

FIG. 1 shows the interaction between cellulose and the dispersant in the composition of the present invention.

FIG. 2 is a flowchart showing an outline of the method for producing a resin composite composition comprising cellulose, a resin, and a dispersant of the present invention.

FIG. 3 is a diagram of the block copolymer of the present invention.

FIG. 4 is photographs showing that cellulose fibers are mixed with and dispersed in various organic solvents using the dispersant of the present invention.

FIG. 5 shows an emulsion of the block copolymer of the present invention in water/NMP.

FIG. 6 is a flowchart showing an outline of the method for producing a composition comprising cellulose and a dispersant of the present invention.

FIG. 7 is photographs showing that lamellae of the resin are formed in the resin composite composition of the present invention.

FIG. 8 is photographs showing that lamellae of the resin are formed in the resin composite composition of the present invention.

FIG. 9 is photographs showing that lamellae of the resin are formed in the resin composite composition of the present invention.

FIG. 10 is a flowchart showing an outline of the method for producing a resin composite composition of the present invention.

FIG. 11 is a flowchart showing an outline of the method for preparing a resin molding material of the present invention.

FIG. 12 is a flowchart of the method for preparing the CNF/P001/NMP dispersion liquid of the Examples.

FIG. 13 is a flowchart of the method for preparing the PE/CNF/P001 resin composition of the Examples.

FIG. 14 is a flowchart of the method for producing the PE/CNF/P001 molded article of the Examples.

FIG. 15 is graphs showing the evaluation results of the tensile strain of a cellulose-fiber-resin molded article obtained using the block copolymer of the Examples.

FIG. 16 is a polarizing microscope image of a cellulose-fiber-resin molded article obtained using the block copolymer of the Examples.

FIG. 17 is an analytical image of a cellulose-fiber-resin molded article obtained using the block copolymer of the Examples, the image being obtained from an X-ray CT scanner.

FIG. 18 is graphs showing the evaluation results of the tensile strain of a cellulose-fiber-resin molded article obtained using the block copolymer of the Examples.

FIG. 19 is a graph showing the evaluation results obtained when trimix drying is used in the process for producing a cellulose-fiber-resin molded article using the block copolymer of the present invention.

FIG. 20 is an analytical image of a cellulose-fiber-resin molded article obtained using the block copolymer of the present invention, the image being obtained from an X-ray CT scanner.

FIG. 21 is graphs showing the evaluation results with respect to a cellulose-fiber-resin molded article produced by using the block copolymer of the present invention.

FIG. 22 is an analytical image of a cellulose-fiber-resin molded article obtained using the block copolymer of the present invention, the image being obtained from an X-ray CT scanner.

FIG. 23 is polarizing microscope images of a sample produced by trimix drying a cellulose-fiber-resin molded article obtained using the block copolymer of the present invention.

FIG. 24 is a flowchart of the method for preparing CNF coated with the block copolymer P001 (dispersant) of the present invention.

FIG. 25 shows (A) FT-IR of CNF coated with the block copolymer P001 (dispersant) of the present invention, and (B) the results in relation to the IR peak ratio with respect to the number of washing cycles.

FIG. 26 shows the contact angle measurement results with respect to CNF coated with the block copolymer P001 (dispersant) of the present invention.

FIG. 27 is photographs showing the dispersibility of CNF coated with the block copolymer P001 (dispersant) of the present invention in organic solvents.

FIG. 28 is a flowchart showing defibration to a nano level by melt-kneading in the Examples (production of CR-3).

FIG. 29 is a flowchart showing defibration to a nano level by kneading at a low temperature in water in the Examples (production of CR-4).

FIG. 30 is a flowchart showing defibration to a nano level by kneading at a low temperature in NMP in the Examples (production of CR-5).

FIG. 31 is a graph showing the resin elastic moduli of CR-3, CR-4, and CR-5 of the Examples.

FIG. 32 shows an observation image of pulp fibers obtained by hot-pressing a dumbbell test piece of CR-3 in the Examples.

FIG. 33 shows an observation image of pulp fibers obtained by hot-pressing a dumbbell test piece of CR-4 in the Examples.

FIG. 34 shows an observation image of pulp fibers obtained by hot-pressing a dumbbell test piece of CR-5 in the Examples.

FIG. 35 is a graph showing the resin elastic moduli in relation to the production using the pulp in the Examples.

FIG. 36 is a graph showing the resin elastic moduli of the dispersants of the present invention.

### DESCRIPTION OF EMBODIMENTS

### (1) Composition Comprising Cellulose and a Dispersant

The composition of the present invention comprises cellulose and a dispersant. The dispersant comprises a resin affinity segment A and a cellulose affinity segment B and has a block copolymer structure or a gradient copolymer structure.

The specific dispersant contained in the composition of the present invention enables improvement in the dispersibility of the cellulose in a resin. When the composition of the present invention is used, the cellulose (preferably a cellulose nanofiber (CNF) or a cellulose nanocrystal (CNC)) is coated with the dispersant, increasing the strength at the interface between the cellulose and a resin.

Therefore, when the composition of the present invention is used to produce a resin composite composition comprising cellulose, a resin, and a dispersant, the produced resin composite composition has excellent strength and a high elastic modulus.

The dispersant contained in the composition of the present invention comprises a resin affinity segment A and a cellulose affinity segment B and has a block copolymer structure or a gradient copolymer structure.

The resin affinity segment A represents the hydrophobic portion and is also referred to as a cellulose-dispersing segment. The cellulose affinity segment B represents the hydrophilic portion and is also referred to as a cellulose-immobilizing segment.

The dispersant has a block copolymer structure or a gradient copolymer structure. The dispersant is preferably an A-B diblock copolymer. The dispersant is preferably designed and synthesized by living radical polymerization (LRP).

FIG. 1 shows the interaction between the cellulose and the dispersant in the composition of the present invention. Due to the dispersant of the present invention, it is possible for cellulose to be mixed with and dispersed in a solvent having low affinity for cellulose under mild conditions of ordinary temperature and ordinary pressure.

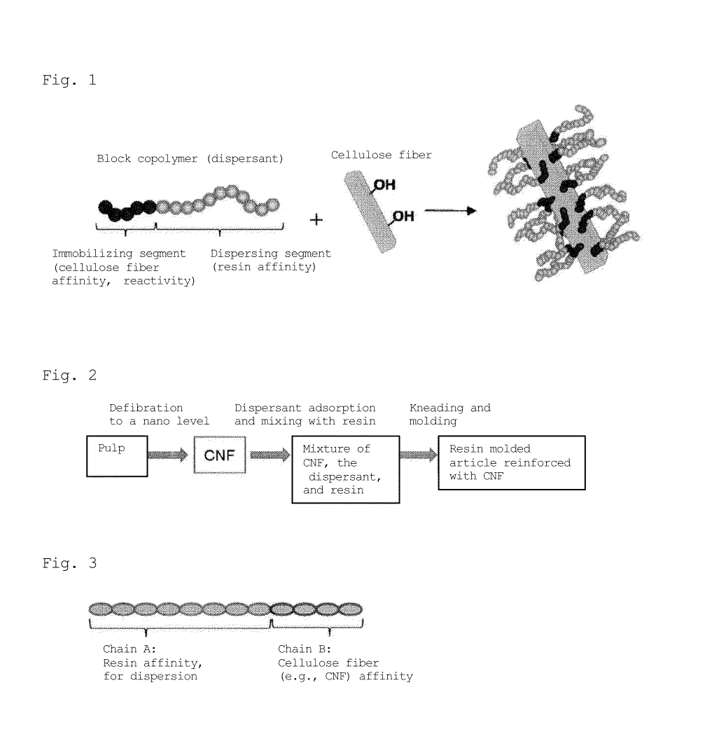

FIG. 2 is a flowchart showing an outline of the method for producing a resin composite composition comprising cellulose, a resin, and a dispersant of the present invention.

Cellulose has hydroxyl groups on its surface and is thus effectively coated with the cellulose affinity segment B of the dispersant. The resin affinity segment A of the dispersant hydrophobizes the cellulose surface. Cellulose that is hydrophobized on its surface is uniformly dispersed even in a thermoplastic resin with very high hydrophobicity, such as polyethylene (PE) or polypropylene (PP).

The resin affinity segment A of the dispersant improves the strength at the interface between cellulose and a resin. The use of the composition of the present invention prevents aggregation of the cellulose in a resin, which makes it possible to obtain composite materials and molded articles having excellent strength and a high elastic modulus.

The dispersant in the composition of the present invention preferably comprises a block copolymer or gradient copolymer containing dicyclopentenyloxyethyl methacrylate (DCPOEMA) as the resin affinity segment A, and preferably comprises hydroxyethyl methacrylate (HEMA) as the cellulose affinity segment B.

The composition of the present invention is preferably produced in a water/N-methylpyrrolidone (NMP)-based emulsion containing cellulose. The composition of the present invention is produced before the cellulose is mixed with a resin (e.g., PE). In this manner, the cellulose does not undergo aggregation in the resin.

The dispersant comprising the resin affinity segment A comprising DCPOEMA and the cellulose affinity segment B comprising HEMA also has effects on PE, PP, polystyrene, and other resins.

When the composition of the present invention produced by using an emulsion of the dispersant in, for example, water/N-methylpyrrolidone (NMP) is mixed with a resin (e.g., PE), followed by defibration of cellulose, it is possible to obtain a resin composite composition (resin molding material or resin molded article) having increased strength.

### (1-1) Cellulose

Examples of plant fibers used as a raw material of cellulose (or cellulose fibers) include pulp obtained from a natural plant fiber raw material, such as wood, bamboo, hemp, jute, kenaf, cotton, beat, agricultural waste, and cloth; and regenerated cellulose fibers such as rayon and cellophane.

Examples of wood include, but are not limited to, Sitka spruce, Cryptomeria japonica, Chamaecyparis obtusa, eucalyptus, acacia, and the like. Examples of paper include, but are not limited to, deinked recycled waste paper, recycled cardboard waste paper, magazines, copy paper, and the like. These plant fibers may be used singly or in a combination of two or more.

Of these, pulp or fibrillated cellulose obtained by fibrillating pulp is preferably used as a raw material.

Preferable examples of pulp include chemical pulp (kraft pulp (KP) and sulfite pulp (SP)), semi-chemical pulp (SCP), chemiground pulp (CGP), chemimechanical pulp (CMP), ground pulp (GP), refiner mechanical pulp (RMP), thermomechanical pulp (TMP), and chemithermomechanical pulp (CTMP), which are obtained by chemically and/or mechanically pulping plant materials; and deinked recycled pulp, cardboard recycled pulp, and magazine recycled pulp, which comprise the above types of pulp as major components. These raw materials may optionally be subjected to delignification or bleaching to control the lignin content in the pulp.

Of these pulp types, various types of kraft pulp derived from softwood with high fiber strength (softwood unbleached kraft pulp (or “NUKP”), oxygen-prebleached softwood kraft pulp (or “NOKP”), and softwood bleached kraft pulp (or “NBKP”) are particularly preferably used.

Cellulose is preferably selected from the group consisting of lignocellulose, cellulose nanofibers (CNFs), cellulose nanocrystals (CNCs), microfibrillated cellulose, pulp, and wood flour.

Pulp consists mainly of cellulose, hemicellulose, and lignin. The lignin content of pulp is not particularly limited, and is typically about 0 to 40 wt %, and preferably about 0 to 10 wt %. The lignin content can be measured by using the Klason method.

In plant cell walls, a cellulose microfibril (single cellulose nanofiber) having a width of about 4 nm is present as the minimum unit. This is a basic skeletal material (basic element) of plants, and the assembly of these cellulose microfibrils forms a plant skeleton.

In the present invention, it is preferable to use nanocellulose as cellulose fibers. In the present invention, the term “nanocellulose” refers to cellulose nanofibers (CNFs) or cellulose nanocrystals (CNCs) obtained by breaking apart the fibers of a cellulose-fiber-containing material (e.g., wood pulp) to a nanosize level (defibration).

“CNF” refers to fibers obtained by subjecting cellulose fibers to a treatment such as mechanical defibration, and CNF has a fiber width of about 4 to 200 nm and a fiber length of about 5 μm or more.

CNF has a specific surface area of preferably about 70 to 300 m²/g, more preferably about 70 to 250 m²/g, and still more preferably about 100 to 200 m²/g. In a composition containing CNF and a resin, the larger the specific surface area of CNF, the larger the contact area; thus, the strength of the composition increases. A specific surface area too large is likely to cause aggregation of CNF in the resin of the resin composition, and desired high-strength materials may not be obtained.

CNF typically has an average fiber diameter of about 4 to 200 nm, preferably about 4 to 150 nm, and particularly preferably about 4 to 100 nm.

Examples of methods for defibrating plant fibers to prepare CNF include a method comprising the step of defibrating a cellulose-fiber-containing material such as pulp.

For example, a defibration method can be used in which an aqueous suspension or slurry of the cellulose-fiber-containing material is mechanically milled or beaten using a refiner, a high-pressure homogenizer, a grinder, a single-screw or multi-screw kneader (preferably twin-screw kneader), a bead mill, or the like. These defibration methods may optionally be combined. For these defibration methods, JP2011-213754A and JP2011-195738A, for example, may be referred to.

CNC refers to crystals obtained by subjecting cellulose fibers to a chemical treatment such as acid hydrolysis, and CNC has a crystal width of about 4 to 70 nm, and a crystal length of about 25 to 3,000 nm.

CNC has a specific surface area of preferably about 90 to 900 m²/g, more preferably about 100 to 500 m²/g, and still more preferably about 100 to 300 m²/g. In a composition containing CNC and a resin, the larger the specific surface area of CNC, the larger the contact area; thus, the strength of the composition is increased. A specific surface area too large is likely to cause aggregation of CNC in the resin of the resin composition, and the desired high-strength materials may not be obtained.

CNC typically has an average crystal width of about 10 to 50 nm, preferably about 10 to 30 nm, and particularly preferably about 10 to 20 nm. CNC typically has an average crystal length of about 500 nm, preferably about 100 to 500 nm, and particularly preferably about 100 to 200 nm.

To prepare CNC by defibrating plant fibers, a known method may be used. For example, a defibration method can be used in which an aqueous suspension or slurry of the cellulose-fiber-containing material mentioned above is subjected to a chemical treatment, such as acid hydrolysis using sulfuric acid, hydrochloric acid, or hydrobromic acid. These defibration methods may optionally be combined.

The average fiber diameter of nanocellulose fibers (average fiber diameter, average fiber length, average crystal width, and average crystal length) is determined by measuring the fiber diameter of at least 50 nanocellulose fibers within the visual field of an electron microscope, and calculating the average.

Nanocellulose has a high specific surface area (preferably about 200 to 300 m²/g), as well as being lighter and stronger than steel. Nanocellulose is also less subject to thermal deformation than glass (low thermal expansion).

Nanocellulose preferably has type-I cellulose crystalline structure, and the crystallinity is preferably as high as 50% or more. The crystallinity of type-I cellulose crystals of nanocellulose is preferably 55% or more, and more preferably 60% or more. The maximum crystallinity of type-I cellulose crystals of nanocellulose is typically about 95%, or about 90%.

Type-I cellulose crystalline structure is as defined in “Cellulose no Jiten” (published by Asakura Shoten, pages 81 to 86, or 93 to 99, new cover, first edition). Most natural cellulose has type-I cellulose crystalline structure. Cellulose fibers having, for example, type-II, type-III, or type-IV cellulose crystalline structure are derived from cellulose having type-I cellulose crystalline structure. In particular, type-I crystalline structure shows a higher crystalline elastic modulus than the other structures.

In the present invention, it is preferable to use nanocellulose having type-I cellulose crystalline structure. With type-I crystals, a composite material comprising such nanocellulose and a matrix resin has a low linear thermal expansion coefficient and high elastic modulus.

Nanocellulose having type-I crystalline structure can be identified by detecting typical peaks at two regions near 2θ=14 to 17° and near 2θ=22 to 23° in the diffraction profile obtained by wide-angle X-ray diffraction image analysis.

For example, ethanol is added to a slurry of nanocellulose to adjust the nanocellulose concentration to 0.5 wt %. Subsequently, the slurry is stirred with a stirrer, and filtration under reduced pressure is quickly started (5C filter paper produced by Advantec Toyo). The obtained wet web is then subjected to compression heating at a temperature of 110° C. and at a pressure of 0.1 t for 10 minutes to thereby obtain a CNF sheet (50 g/m²).

The CNF sheet is then measured to determine the crystallinity of type-I cellulose crystals by using an X-ray generator (UltraX18HF produced by Rigaku Corporation) under the following conditions: a target of Cu/Kα line, a voltage of 40 kV, an electric current of 300 mA, a scan angle of (28) 5.0 to 40.0°, and a step angle of 0.02°.

The degree of polymerization of natural cellulose is 500 to 10,000, and that of regenerated cellulose is about 200 to 800. Cellulose is formed by extended-chain crystals in which bundles of β-1,4 linked, linearly extended cellulose fibers are fixed by intramolecular or intermolecular hydrogen bonds.

Although X-ray diffraction or solid-state NMR spectroscopy reveals that cellulose crystals have a variety of crystalline structures, natural cellulose has only type-I crystalline structure.

From analysis such as X-ray diffraction, the proportion of the crystalline region in wood pulp cellulose is estimated to be about 50 to 60%, and that of bacterial cellulose is estimated to be higher, about 70%.

Because of its extended-chain crystal form, cellulose is not only highly elastic, but also five times stronger than steel, while having a linear thermal expansion coefficient equal to or below 1/50 that of glass. In other words, destroying the crystalline structure of cellulose results in a loss of the excellent characteristics of cellulose, such as a high elastic modulus and high strength.

Cellulose fibers are typically insoluble in commonly used solvents as well as in water.

In known techniques for cellulose fiber modification, cellulose is dissolved in a mixture solution of dimethylacetamide (DMAc)/LiCl and subjected to a modification treatment. Dissolving cellulose fibers in this manner causes strong interaction between the solvent components and the hydroxyl groups of cellulose fibers to thereby cleave the intramolecular or intermolecular hydrogen bonds in cellulose fibers. The cleavage of the hydrogen bonds increases the flexibility of the molecular chain, which leads to an enhanced solubility. In other words, dissolution of cellulose fibers means destruction of the crystalline structure of cellulose fibers.

However, dissolved cellulose fibers, i.e., cellulose fibers that have lost the crystalline structure, cannot exhibit excellent features of cellulose fibers, such as a high elastic modulus and high strength. Thus, in the related art, surface modification of cellulose fibers while maintaining the crystalline structure of cellulose fibers was very difficult.

### (1-2) Dispersant

The dispersant comprises a resin affinity segment A and a cellulose affinity segment B and has a block copolymer structure or a gradient copolymer structure.

The block copolymer structure refers to a structure in which two or more polymer chains A, B, C, . . . , with different properties (e.g., polarity) are bonded in a linear manner (e.g., A-B, A-B-A, and A-B-C). Examples include an A-B block copolymer structure, in which polymer chain A and polymer chain B are bonded in a linear manner. The block copolymer structure may be obtained by known living polymerization.

The dispersant comprises a resin affinity segment A and a cellulose affinity segment B and preferably has an A-B diblock copolymer structure. The monomer units constituting the resin affinity segment A and the cellulose affinity segment B are preferably vinyl monomer units, and preferably include at least one monomer unit selected from the group consisting of (meth)acrylate-based monomers, (meth)acrylamide-based monomers, and styrene-based monomers. FIG. 3 shows a diagram of the block copolymer of the present invention.

Taking a copolymer comprising repeating units derived from monomers A and B with different properties (e.g., polarity) as an example, the gradient copolymer structure refers to a structure with a repeating-unit distribution gradient, such that the proportion of unit A decreases while the proportion of unit B increases from one end of a polymer chain with abundant unit A to the other end with abundant unit B. The gradient copolymer structure may be obtained by known living polymerization.

Cellulose fibers have hydroxyl groups on their surface, and are thus effectively coated with the cellulose affinity segment B in an A-B diblock copolymer structure or an A-B gradient copolymer structure.

The resin affinity segment A in an A-B diblock copolymer structure or an A-B gradient copolymer structure hydrophobizes the surface of cellulose fibers.

Due to the dispersant, it is possible for cellulose fibers to be mixed with and dispersed in an organic solvent that originally has low affinity for cellulose under mild conditions of ordinary temperature and ordinary pressure (FIG. 4).

The hydrophobized cellulose is uniformly dispersed even in a thermoplastic resin with very high hydrophobicity, such as PE or PP. The dispersant improves the strength at the interface between the cellulose and the resin, which prevents aggregation of the cellulose in the resin. This makes it possible to obtain composite materials and molded articles having excellent strength and a high elastic modulus.

### (1-2-1) Resin Affinity Segment A

The resin affinity segment A hydrophobizes the cellulose surface via the cellulose affinity segment B.

As a resin affinity segment, the segment must basically have a structure similar to that of the target resin or have hydrophobicity similar to that of the target resin.

The monomer units constituting the resin affinity segment A preferably include at least one monomer unit selected from the group consisting of (meth)acrylate-based monomers, (meth)acrylamide-based monomers, and styrene-based monomers.

The resin affinity segment A is preferably composed of repeating units comprising monomer components, such as lauryl methacrylate (LMA), tert-butylcyclohexyl methacrylate (tBCHMA), cyclohexyl methacrylate (CHMA), methyl methacrylate (MMA), isobornyl methacrylate (IBOMA), dicyclopentenyloxyethyl methacrylate (DCPOEMA), and dicyclopentanyl methacrylate (DCPMA). These monomer components may be used singly or in a combination of two or more.

Examples of preferable monomer components include CₙH₂ₙ₊₁ groups, such as MMA and LMA, and components having alkyl, such as components having branched alkyl and components having a plurality of alkyl groups. Components having unsaturated alkyl are also preferable.

It is possible to use monomer components having an aromatic ring, such as benzyl methacrylate, polycyclic aromatics (e.g., naphthalene), and substituted aromatics (e.g., o-methoxybenzyl methacrylate). Alicyclic compounds, such as DCPOEM, are preferable. A resin fragment having a functional group (e.g., a hydroxyl group or a double bond) at an end, such as polyethylene having a double bond or a hydroxyl group at an end, is preferable.

Polylactic acid, polyamide, and the like, which has a reactive functional group at an end, may be directly used as the resin affinity segment A.

Small molecules, such as oligoethylene and stearic acid, are preferable. Resin fragments intramolecularly having a functional group, such as MAPP (maleic acid-modified PP), are preferable. Graft polymerization of the cellulose affinity segment may be performed by using the modified moiety as the starting point.

The chemical structures and abbreviations of preferable repeating units (monomer components) constituting the resin affinity segment A are shown below. (a) represents repeating units of the resin affinity segment A.

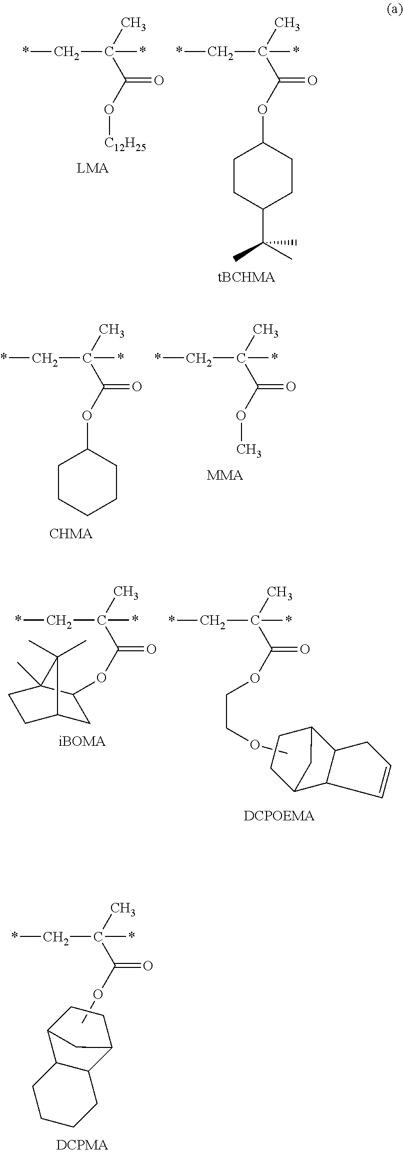

Table 1 shows a preferable mode of the resin affinity segment A.

TABLE 1

| Monomer units | Number | Molecular | |
|---|---|---|---|
| Constituting | average | weight | Number average |
| the resin | Molecular | distribution | Polymerization |
| affinity segment A | weight (Mn) | index (Mw/Mn) | degree (DPn) |
| LMA | 4900-10000 | 1.31 | 19-39 |
| tBCHMA | 4000-8000 | 1.28-1.36 | 18-36 |
| MMA | 6610 | 1.35 | 66 |
| CHMA | 4350-4820 | 1.31-1.52 | 26-29 |
| IBOMA | 2380-4220 | 1.19-1.38 | 11-19 |
| DCPOEMA | 3300-6730 | 1.29-1.43 | 13-26 |
| DCPMA | 4050 | 1.43 | 17 |

The resin affinity segment A is preferably composed of monomer components, such as dicyclopentenyloxyethyl methacrylate (DCPOEMA) blocks, lauryl methacrylate (LMA) blocks, tert-butylcyclohexyl methacrylate (tBCHMA) blocks, dicyclopentanyl methacrylate (DCPMA) blocks, and the like.

Preferable monomer units constituting the resin affinity segment A are shown below.

(Meth)acrylates containing alkyl, alkenyl, cycloalkyl, or an aromatic ring, such as methyl (meth)acrylate, butyl (meth)acrylate, t-butyl (meth)acrylate, hexyl (meth)acrylate, 2-ethylhexyl (meth)acrylate, lauryl (meth)acrylate, tetradecyl (meth)acrylate, octadecyl (meth)acrylate, cyclohexyl (meth)acrylate, isobornyl (meth)acrylate, trimethylcyclohexyl (meth)acrylate, cyclodecyl (meth)acrylate, cyclodecylmethyl (meth)acrylate, tricyclodecyl (meth)acrylate, benzyl (meth)acrylate, and allyl (meth)acrylate.

(Meth)acrylates containing halogen elements, such as tetrahydrofurfuryl (meth)acrylate, octafluorooctyl (meth)acrylate, and tetrafluoroethyl (meth)acrylate.

The resin affinity segment A has a number average molecular weight determined by gel permeation chromatography on a polystyrene basis of preferably about 100 to 20,000, more preferably about 500 to 10,000, and still more preferably about 1,000 to 8,000.

This molecular weight range is considered to achieve the highest adsorption efficiency of the resin affinity segment A. The resin affinity segment A preferably has a number average molecular weight of about 1,000 to 8,000 to exert resin affinity for resin (compatibility with resin).

The resin affinity segment A has a number average polymerization degree (the average number of repeating units) of preferably about 1 to 200, more preferably about 5 to 100, and still more preferably about 10 to 50.

This molecular weight range is considered to achieve the highest adsorption efficiency of the resin affinity segment A. The resin affinity segment A preferably contains at least a pentamer to achieve multi-point interaction with resin.

The monomer units constituting the resin affinity segment A are preferably selected from a hydrophobic monomer group including (meth)acrylate-based monomers, styrene-based monomers, and the like.

### (1-2-2) Cellulose Affinity Segment B

The cellulose affinity segment B interacts with the hydroxyl groups present on the cellulose surface through hydrogen bonds or the like. The cellulose affinity segment B of the dispersant contains a large number of hydroxyl groups, carboxyl groups, amide groups, and the like. The cellulose affinity segment B is thus easily adsorbed on the cellulose surface to form multi-point hydrogen bonds with cellulose fibers due to the polymer effect, and is not easily desorbed.

The cellulose surface is known to have a negative zeta potential, and cellulose materials include hemicellulose (partially including a negative-charge-containing unit, such as glucuronic acid). Therefore, the cellulose affinity segment B containing a large number of cationic functional groups, such as quaternary ammonium salts, is well adsorbed onto cellulose fibers. The cellulose affinity segment B may react with the hydroxyl groups on the cellulose surface.

The monomer units constituting the cellulose affinity segment B preferably comprises at least one monomer unit selected from the group consisting of (meth)acrylate-based monomers, (meth)acrylamide-based monomers, and styrene-based monomers.

The chain of cellulose affinity segment B is preferably a segment containing a hydroxyl group (HEMA, sugar residues, etc.), a carboxylic acid, an amide (urea, urethane, amidine, etc.), and a cationic moiety (quaternary ammonium salt), considering that they exhibit hydrogen bonding properties with respect to cellulose.

Among preferable repeating units (monomer components) constituting the cellulose affinity segment B, preferable examples of monomers exhibiting hydrogen bonding properties with respect to cellulose include hydroxyethyl methacrylate (HEMA), methacrylic acid (MAA), methacryl amide (MAm), quaternized dimethyl aminoethyl methacrylate (QDEMAEMA), benzylated compounds thereof, and the like. These monomer components may be used singly or in a combination of two or more.

The cellulose affinity segment B preferably contains, for example, an isocyanate group, an alkoxysilyl group, a boric acid, and a glycidyl group, considering that they are functional groups that can be reacted with hydroxyl groups of cellulose.

Among preferable repeating units (monomer components) constituting the cellulose affinity segment B, preferable examples of monomers that are reactive with cellulose fibers include 3-methacryloxypropyl triethoxysilane (MPE), methacryloyloxyethyl isocyanate (MOI), methacrylic acid glycidyl ester (GMA), and the like. These monomer components may be used singly or in a combination of two or more.

The chemical structures and abbreviations of preferable repeating units (monomer components) constituting the cellulose affinity segment B are shown below. (b) is repeating units of the cellulose affinity segment B, and interacts with cellulose. (c) is repeating units of the cellulose affinity segment B, and shows reactivity with cellulose.

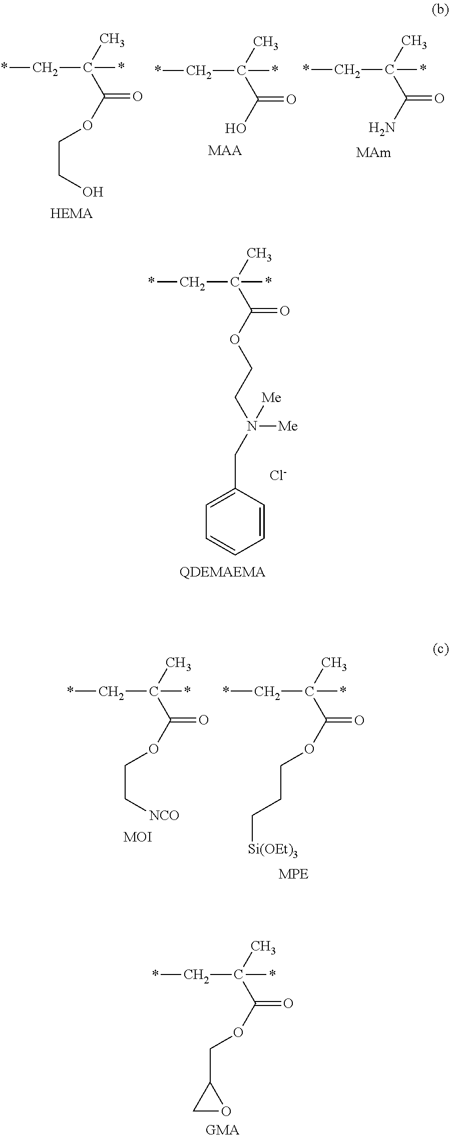

Table 2 shows a preferable mode of the cellulose affinity segment B.

TABLE 2

| Monomer units | | |
|---|---|---|
| constituting the | Number average | Number average |
| cellulose affinity | Molecular | Polymerization |
| segment B | weight (Mn) | Degree (DPn) |
| HEMA | 1700-3800 | 16-29 |
| MAA | 1000-2000 | 12-24 |
| QDEMAEMA | 1800-2200 | 6-8 |
| MOI/MMA (38.1/58.3) | 1500-2300 | — |
| MAm/HEMA (38.1/58.3) | 1000-2000 | — |

The cellulose affinity segment B preferably contains hydroxyethyl methacrylate (HEMA).

The cellulose affinity segment B has a number average molecular weight determined by gel permeation chromatography on a polystyrene basis of preferably about 100 to 20,000, more preferably about 500 to 10,000, and still more preferably about 1,000 to 8,000.

This molecular weight range is considered to achieve the highest adsorption efficiency of the cellulose affinity segment B. The cellulose affinity segment B preferably has a number average molecular weight of about 1,000 to 8,000 to achieve multi-point interaction with cellulose.

The cellulose affinity segment B has a number average polymerization degree (the average number of repeating units) of preferably about 1 to 200, more preferably about 5 to 100, and still more preferably about 10 to 50.

This molecular weight range is considered to achieve the highest adsorption efficiency of the cellulose affinity segment B. The cellulose affinity segment B preferably contains at least a decamer to achieve multi-point interaction with cellulose.

The monomer units constituting the cellulose affinity segment B preferably comprises (meth)acrylate-based monomers, (meth)acrylamide-based monomers, and styrene-based monomers.

Examples include hydroxy-containing (meth)acrylates, such as 2-hydroxy ethyl (meth)acrylate, 2-hydroxy propyl (meth)acrylate, and 3-hydroxy propyl (meth)acrylate, mono (meth)acrylates of polyalkylene glycol, such as polyethylene glycol mono (meth)acrylate, and polypropylene glycol mono (meth)acrylate; glycol ether-based (meth)acrylates, such as (poly)ethylene glycol monomethyl ether (meth)acrylate, (poly)ethylene glycol monoethyl ether (meth)acrylate, and (poly)propylene glycol monomethyl ether (meth)acrylate; and the like.

The “poly” and “(poly)” above all represent n=2 or more.

Examples include glycidyl-containing (meth)acrylates, such as glycidyl (meth)acrylate, 3,4-epoxy cyclohexyl (meth)acrylate, (meth)acryloyloxy ethyl glycidyl ether, and (meth)acryloyloxy ethoxyethyl glycidyl ether; isocyanate-containing (meth)acrylates, such as (meth)acryloyloxy ethylisocyanate, 2-(2-isocyanatoethoxy) ethyl (meth)acrylate, and monomers in which the isocyanate groups of these isocyanate monomers are blocked with ε-caprolactone, MEK oxime, pyrazole, or the like; oxygen atom-containing cyclic (meth)acrylates, such as oxetanyl methyl (meth)acrylate; amino group-containing (meth)acrylates, such as dimethylamino ethyl (meth)acrylate, diethylamino ethyl (meth)acrylate, and t-butylamino ethyl (meth)acrylate, and quaternary ammonium salts thereof; and the like.

It is also possible to use monomers, such as silicon-atom-containing (meth)acrylates containing a trimethoxysilyl group or a dimethyl silicone chain. Further, it is also possible to use macromonomers obtained by introducing a (meth)acryl group to one end of an oligomer that is obtained by polymerizing various monomers mentioned above.

To obtain a block, acrylic-based polymers obtained from (meth)acrylate monomers containing functional groups such as hydroxyl and carboxyl may be reacted with (meth)acrylates containing groups that can react with the functional groups, such as isocyanate ethyl (meth)acrylate and glycidyl (meth)acrylate.

### (1-2-3) Dispersant

The dispersant is preferably synthesized by living polymerization, and is more preferably synthesized by living radical polymerization.

The dispersant is preferably a vinyl polymer. In particular, the dispersant is preferably composed of at least one monomer unit selected from the group consisting of (meth)acrylate-based monomers, (meth)acrylamide-based monomers, and styrene-based monomers.

Segments obtained by methods other than living radical polymerization may also be used as the resin affinity segment A and the cellulose affinity segment B. For example, an oligoethylene chain, an oligopropylene chain, polylactic acid, and the like are preferable for the resin affinity segment A, and an polyoxyethylene (PEO), an oligosaccharide, and the like are preferable for the cellulose affinity segment B.

In this case, it is preferable to synthesize one of the segments by living radical polymerization, and use existing polymers, oligomers, or the like, as the other block.

The cellulose affinity segment B preferably contains a functional group that can react with the hydroxyl groups of cellulose, such as isocyanate group, alkoxysilyl group, boric acid, and glycidyl group.

As the basic design, the dispersant comprises the resin affinity segment A and the cellulose affinity segment B and is preferably an A-B diblock copolymer or an A-B gradient copolymer. Additionally, an A-B-A triblock copolymer, a graft copolymer obtained by grafting polymer A with polymer B, a star copolymer, such as (A-B)n, and the like, are also preferable.

The proportion of the resin affinity segment A in the entire dispersant is preferably about 5 to 95 mass %, more preferably about 20 to 95 mass %, and still more preferably about 40 to 70 mass %.

The proportion of the cellulose affinity segment B in the entire dispersant is preferably about 5 to 95 mass %, more preferably about 5 to 60 mass %, and still more preferably about 10 to 50 mass %.

If the proportion of the cellulose affinity segment B is smaller, cellulose will not be sufficiently coated. If the cellulose affinity segment B has a larger number average molecular weight, or the proportion of the cellulose affinity segment B in the entire dispersant is larger, the solubility will worsen, or adsorption among cellulose particles will occur, possibly causing insufficient dispersion of fine particles.

The resin affinity segment A and the cellulose affinity segment B preferably comprise a relatively intermediate molecular weight polymer having a length of about 10 to 20 nm in the entire dispersant. The length of the resin affinity segment A and the cellulose affinity segment B is more preferably about 1 to 50 nm, and still more preferably about 1 to 10 nm.

The dispersant has a number average molecular weight determined by gel permeation chromatography on a polystyrene basis of preferably about 200 to 40,000, more preferably about 1,000 to 20,000, and still more preferably about 2,000 to 10,000.

If a dispersant having a smaller molecular weight is added to an article, the properties of the article can worsen. A dispersant having a larger molecular weight tends to worsen solubility. For example, when the dispersant is used to obtain a cellulose dispersion, the property of easy dispersal of cellulose, which is a remarkable effect of the present invention, can become unsatisfactory.

The dispersant has a molecular weight distribution index (weight average molecular weight/number average molecular weight) of preferably about 1.0 to 1.6, more preferably about 1.0 to 1.5, and still more preferably about 1.0 to 1.4.

The molecular weight distribution index (weight average molecular weight/number average molecular weight) of a dispersant represents the degree of molecular weight distribution. A small value of the molecular weight distribution index indicates a narrow molecular weight distribution of the dispersant, i.e., a high uniformity of the molecular weight.

When the molecular weight distribution index is small, the solubility on a micro level is assumed to be molecularly similar, which indicates improved solubility of the dispersant, thus easily achieving a finely dispersed dispersion state. A narrow molecular weight distribution indicates small amounts of larger or smaller molecular weights, thus achieving uniform properties of the dispersant.

This minimizes the worsening of solubility due to large molecular weights, as well as minimizing adverse effects on the articles due to small molecular weights, further improving the effect of the dispersant, i.e., giving a highly finely dispersed dispersion state.

Table 3 shows a preferable mode of the dispersant.

TABLE 3

| Number average molecular | Molecular weight distribution |
|---|---|
| Weight (Mn) of | Index (Mw/Mn) of |
| the entire dispersant | the entire dispersant |
| 4480-11300 | 1.28-1.6 |

The dispersant preferably has an A-B block copolymer structure made of the resin affinity segment A and the cellulose affinity segment B.

The block copolymer is preferably designed and synthesized by living radical polymerization (LRP), and is preferably a vinyl polymer obtained by living radical polymerization.

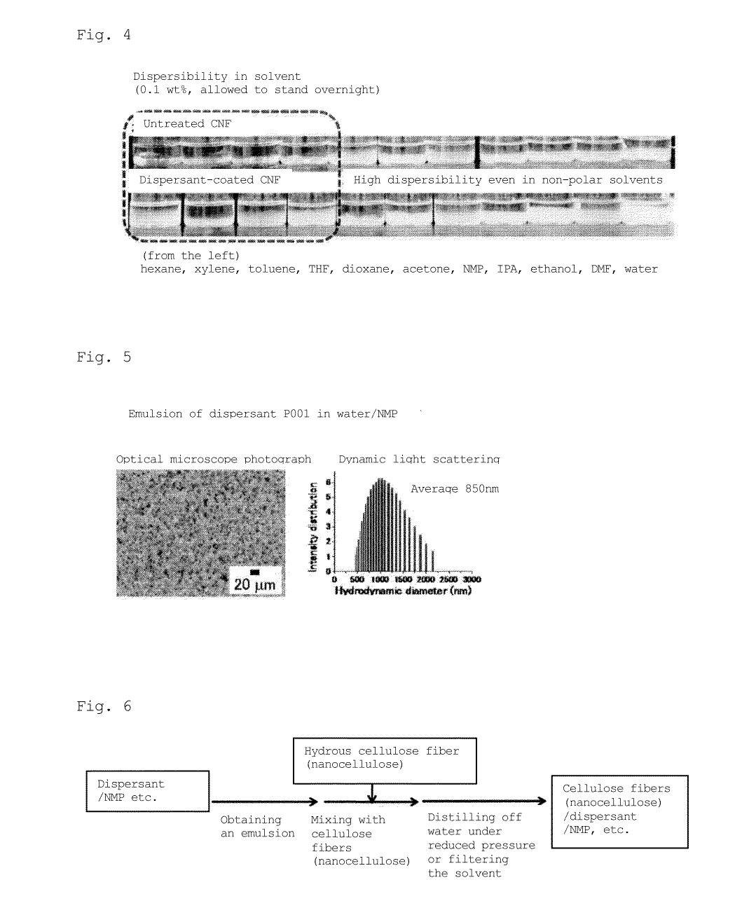

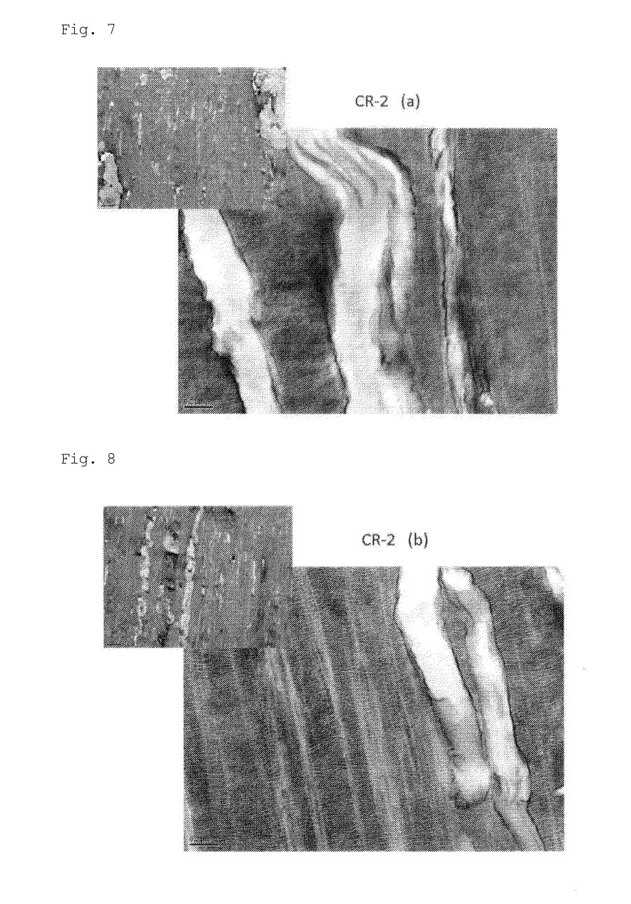

The block copolymer is preferably added as an emulsion to a water/N-methylpyrrolidone (NMP)-based slurry containing cellulose. The emulsion is preferably prepared in water/NMP (FIG. 5).

The addition of block copolymer when a resin (e.g., PE) is mixed with cellulose prevents aggregation of cellulose.

The addition of the block copolymer of the present invention to a water/N-methylpyrrolidone (NMP)-based emulsion containing cellulose and a resin (e.g., PE) increases the strength of a resin composition (molding material, molded article) through a cellulose defibration step.

The dispersant preferably has a gradient copolymer structure formed of the resin affinity segment A and the cellulose affinity segment B. In the gradient copolymer structure formed of the resin affinity segment A and the cellulose affinity segment B, monomer a constituting the resin affinity segment A and monomer b constituting the cellulose affinity segment B are two types of monomers having different polarities.

The gradient copolymer structure preferably has a repeating-unit distribution gradient such that the proportion of monomer a decreases while the proportion of monomer b increases from one end of a polymer chain with abundant monomer a to the other end with abundant monomer b.

### (1-2-4) Method for Producing a Dispersant

Monomers (e.g., tBCHMA) for constituting the resin affinity segment A are dissolved in an amphiphilic solvent (e.g., propylene glycol or monopropyl ether) and subjected to a living radical polymerization in the presence of a catalyst. After a predetermined duration of time, monomers (e.g., HEMA) for constituting the cellulose affinity segment B are added thereto to synthesize a block copolymer.

The prepared block copolymer solution is added dropwise to hydrous methanol to obtain a precipitate as a solid. The catalyst and monomer residues may be removed. The obtained solid (a block copolymer or a gradient copolymer) is dissolved in a solvent, which is then added dropwise to a poor solvent (e.g., acetone) to perform reprecipitation for purification.

A living radical polymerization refers to a polymerization reaction in which a chain transfer reaction and a termination reaction do not substantially occur in a radical polymerization reaction, and the growing chain end maintains its activity even after the monomers have exhaustively reacted.

According to this polymerization reaction, an end of the generated polymer maintains the polymerization activity even after completion of the polymerization reaction. Therefore, the addition of monomers makes it possible to start the polymerization reaction again.

Living radical polymerization has features such as capability to synthesize a polymer having a desired average molecular weight by adjusting the ratio of concentrations of the monomers to the polymerization initiator, capability to produce a polymer having a very narrow molecular weight distribution, and applicability for synthesizing block copolymers.

A living radical polymerization may be abbreviated as “LRP” or may be called a “controlled radical polymerization.”

As monomers, the polymerization method used in the present invention uses radically polymerizable monomers. A radically polymerizable monomer refers to a monomer having an unsaturated bond that may be subjected to a radical polymerization in the presence of an organic radical. Such an unsaturated bond may be a double bond or triple bond. That is, it is possible for the polymerization method used in the present invention to use any monomer that has been known to be used for living radical polymerization.

More specifically, “vinyl monomers” may be used. The term “vinyl monomer” is a collective term for monomers represented by the general formula: CH₂═CR5R6.

The monomers represented by this general formula in which R5 is methyl and R6 is carboxylate are referred to as methacrylate-based monomers and may be suitably used in the present invention.

Specific examples of the methacrylate-based monomers include methyl methacrylate, ethyl methacrylate, propyl methacrylate, n-butyl methacrylate, t-butyl methacrylate, hexyl methacrylate, 2-ethylhexyl methacrylate, nonyl methacrylate, benzyl methacrylate, glycidyl methacrylate, cyclohexyl methacrylate, lauryl methacrylate, n-octyl methacrylate, 2-methoxyethyl methacrylate, butoxyethyl methacrylate, methoxytetraethyleneglycol methacrylate, 2-hydroxyethyl methacrylate, 2-hydroxypropyl methacrylate, 3-chloro-2-hydroxypropyl methacrylate, tetrahydrofurfuryl methacrylate, 2-hydroxy-3-phenoxypropyl methacrylate, diethyleneglycol methacrylate, polyethyleneglycol methacrylate, 2-(dimethylamino)ethyl methacrylate, and the like. It is also possible to use methacrylic acid.

The vinyl monomers represented by the general formula above in which R5 is hydrogen and R6 is carboxylate are generally referred to as acrylic-based monomers and may be suitably used in the present invention.

Specific examples of the acrylate-type monomers include methyl acrylate, ethyl acrylate, propyl acrylate, n-butyl acrylate, t-butyl acrylate, hexyl acrylate, 2-ethylhexyl acrylate, nonyl acrylate, benzyl acrylate, glycidyl acrylate, cyclohexyl acrylate, lauryl acrylate, n-octyl acrylate, 2-methoxyethyl acrylate, butoxyethyl acrylate, methoxytetraethyleneglycol acrylate, 2-hydroxyethyl acrylate, 2-hydroxypropyl acrylate, 3-chloro-2-hydroxypropyl acrylate, tetrahydrofurfuryl acrylate, 2-hydroxy-3-phenoxypropyl acrylate, diethyleneglycol acrylate, polyethyleneglycol acrylate, 2-(dimethylamino)ethyl acrylate, and the like. It is also possible to use acrylic acid.

The vinyl monomer represented by the general formula above in which R5 is hydrogen and R6 is phenyl is styrene, which may be suitably used in the present invention. The monomers represented by the general formula in which R6 is phenyl or a phenyl derivative are referred to as styrene derivatives, which may be suitably used in the present invention. Specific examples include o-, m-, and p-methoxystyrenes, o-, m-, and p-t-butoxystyrenes, o-, m-, and p-chloromethylstyrenes, o-, m-, and p-chlorostyrenes, o-, m-, and p-hydroxystyrenes, o-, m-, p-styrenesulfonic acids, and the like. Examples also include vinylnaphthalene represented by the general formula above in which R6 is aromatic.

The vinyl monomer represented by the above general formula in which R5 is hydrogen and R6 is alkyl is alkylene, which may be suitably used in the present invention.

In the present invention, monomers having two or more vinyl groups may also be used. Specific examples include diene-based compounds (e.g., butadiene and isoprene), compounds having two allyl-based groups (e.g., diallyl isophthalate), a dimethacrylate of a diol compound, a diacrylate of a diol compound, and the like.

Vinyl monomers other than those mentioned above may also be used in the present invention. Specific examples include vinyl esters (e.g., vinyl acetate, vinyl propionate, vinyl benzoate, and vinyl acetate), styrene derivatives other than those mentioned above (e.g., α-methylstyrene), vinyl ketones (e.g., vinyl methyl ketone, vinyl hexyl ketone, and methyl isopropenyl ketone), N-vinyl compounds (e.g., N-vinyl pyrrolidone, N-vinyl pyrrole, N-vinyl carbazole, and N-vinyl indole), (meth)acrylamides and its derivatives (e.g., N-isopropylacrylamide, N-isopropylmethacrylamide, N,N-dimethylacrylamide, N,N-dimethylmethacrylamide, N-methylolacrylamide, and N-methylolmethacrylamide), acrylonitrile, methacrylonitrile, maleic acid and its derivatives (e.g., maleic anhydride), halogenated vinyls (e.g., vinyl chloride, vinylidene chloride, tetrachloroethylene, hexachloropropylene, and vinyl fluoride), olefins (e.g., ethylene, propylene, 1-hexene, and cyclohexene), and the like.

These monomers may be used singly or in a combination of two or more.

A living radical polymerization method is applicable to homopolymerization, i.e., a production of a homopolymer. It is also possible to produce a copolymer by copolymerization. The resin affinity segment or the cellulose affinity segment may each be obtained through random copolymerization.

The block copolymer may be a copolymer having two or more types of blocks linked together, or may be a copolymer having three or more types of blocks linked together.

A block copolymer having two types of blocks may be obtained by using a method comprising, for example, the step of polymerization of a first block and the step of polymerization of a second block. In this case, the step of polymerization of the first block may be performed by a living radical polymerization, and the step of polymerization of the second block may be performed by a living radical polymerization. It is preferable for both the step of polymerization of the first block and the step of polymerization of the second block to be performed by a living radical polymerization.

More specifically, for example, after the polymerization of the first block, the polymerization of the second block may be performed in the presence of the obtained first polymer to thereby obtain a block copolymer.

The first polymer may be isolated and purified to be supplied to the polymerization of the second block. Alternatively, without isolation or purification of the first polymer and in the middle of or at the completion of the polymerization of the first polymer, the second monomer may be added to the first polymerization to perform the polymerization of the blocks.

To produce a block copolymer having three types of blocks, the steps of polymerization of the respective blocks may be performed to obtain a desired copolymer, as in the production of a copolymer having two or more types of blocks linked together.

### (1-2) Proportions in the Composition

The dispersant and cellulose may be contained in the composition to an extent such that the cellulose can be dispersed.

The amount of the dispersant in the composition may be set to about 50 parts by mass per 100 parts by mass of cellulose. In this manner, it is possible to disperse cellulose.

The dispersant is more preferably contained in the composition in an amount of about 5 to 200 parts by mass, still more preferably about 10 to 150 parts by mass, and particularly preferably about 20 to 100 parts by mass, per 100 parts by mass of cellulose.

### (2) Method for Producing a Composition Comprising Cellulose and a Dispersant

FIG. 6 is a flowchart showing an outline of the method for producing a composition comprising cellulose and a dispersant of the present invention. It is a cellulose dispersion containing a dispersant. The use of nanocellulose makes it possible to increase the specific surface area.

When cellulose (e.g., pulp, CNF, or CNC) and a resin (e.g., PP or PE) are mixed, the cellulose and the resin undergo phase separation, causing the deposition of cellulose fibers. The addition of the dispersant as a water/N-methylpyrrolidone (NMP) emulsion before mixing the cellulose with the resin prevents the aggregation of cellulose. A cellulose defibration step performed in the coexistence of the dispersant emulsion increases the strength of the resulting resin composition (molding material, molded article).

Cellulose may be one modified with the cellulose affinity segment B of the dispersant.

Cellulose may be modified while being dispersed in a solvent using the dispersant, i.e., in an inhomogeneous solution. A modification treatment without dissolving cellulose maintains type-I cellulose crystalline structure in the cellulose, thereby enabling the production of modified cellulose maintaining the properties, such as high strength and low thermal expansion.

The modified cellulose maintains type-I cellulose crystalline structure and also exhibits properties such as high strength and low thermal expansion.

### (3) Composition Containing a Resin and a Dispersant

The resin composition of the present invention comprises a resin and a dispersant. The dispersant comprises a resin affinity segment A and a cellulose affinity segment B and has a block copolymer structure or a gradient copolymer structure.

The dispersant is as described above.

### (3-1) Resin

The resin component is not particularly limited. Examples include thermoplastic resins and thermosetting resins.

Thermoplastic resins, which are easily molded, are preferably used as the resin component. Examples of thermoplastic resins include olefin-based resins, nylon resins, polyamide-based resins, polycarbonate-based resins, polysulfone-based resins, polyester-based resins, and cellulose-based resins, such as triacetylcellulose and diacetylcellulose.

Examples of polyamide-based resins include polyamide 6 (PA6, ring-opened polymer of ε-caprolactam), polyamide 66 (PA66, polyhexamethylene adipamide), polyamide 11 (PA11, a polyamide obtained by ring-opening polycondensation of undecanelactam), and polyamide 12 (PA12, a polyamide obtained by ring-opening polycondensation of lauryl lactam).

The thermoplastic resin is preferably an olefin-based resin because its resin composition can fully obtain reinforcement effects, and olefin-based resins are inexpensive.

Examples of olefin-based resins include polyethylene-based resins, polypropylene-based resins, vinyl chloride resins, styrene resins, (meth)acrylic resins, and vinyl ether resins. These thermoplastic resins may be used singly, or in a combination of two or more as a resin mixture.

Of these olefin-based resins, polyethylene-based resins (PE), such as high-density polyethylene (HDPE), low-density polyethylene (LDPE), and biopolyethylene, polypropylene-based resins (PP), vinyl chloride resins, styrene resins, (meth)acrylic resins, and vinyl ether resins are preferable because their resin composition can fully obtain reinforcement effects, and these olefin-based resins are inexpensive.

As a compatibilizer, a resin obtained by adding maleic anhydride, epoxy, or the like to a thermoplastic or thermosetting resin to thereby introduce a polar group (e.g., maleic anhydride modified polyethylene resin, and maleic anhydride modified polypropylene resin) and various commercially available compatibilizers may be used in combination.

These resins may be used singly or in a combination of two or more as a resin mixture. In the use of a resin mixture containing two or more such resins, a maleic anhydride modified resin and other polyolefin-based resin may be used in combination.

When a resin mixture of a maleic anhydride modified resin and another polyolefin-based resin is used, the thermoplastic or thermosetting resin (A) contains a maleic anhydride modified resin preferably in an amount of about 1 to 40% by mass, and more preferably about 1 to 20% by mass.

Specific examples of resin mixtures include mixtures of a maleic anhydride modified polypropylene-based resin and a polyethylene resin or a polypropylene resin, and mixtures of a maleic anhydride modified polyethylene resin and a polyethylene resin or a polypropylene resin.

In addition to the components mentioned above, the resin composition may comprise the following additives: for example, compatibilizers; surfactants; polysaccharides, such as starch and alginic acid; natural proteins, such as gelatin, glue, and casein; inorganic compounds, such as tannin, zeolite, ceramics, and metal powder; colorants; plasticizers; flavoring agents; pigments; flow regulating agents; leveling agents; conducting agents; antistatic agents; UV absorbers; UV dispersers; and deodorants.

Such optional additives can be contained in an amount to the extent that the effect of the present invention is not impaired. For example, the resin composition comprises an optional additive in an amount of preferably about 10% by mass or less, and more preferably about 5% by mass or less.

### (3-2) Proportions in Resin Composition

The dispersant is contained in the resin composition in an amount that achieves properties required of a cellulose-containing resin composite composition.

The amount of the dispersant contained in the resin composition is set to about 5 parts by mass per 100 parts by mass of the resin. In this manner, the reinforcement effect of cellulose is obtained. The amount of cellulose equal to 5 part by mass or higher provides a higher dispersion effect.

The dispersant is more preferably contained in the composition in an amount of about 1 to 20 parts by mass, still more preferably about 2 to 10 parts by mass, and particularly preferably about 5 to 10 parts by mass, per 100 parts by mass of the resin.

The resin composition according to the present invention comprises a resin as a matrix. When the resin composition, which contains the dispersant, is mixed with cellulose, it is possible to improve the affinity at the interface between the cellulose and the resin.

### (4) Resin Composite Composition Comprising Cellulose, a Resin, and a Dispersant

The resin composite composition of the present invention comprises cellulose, a resin, and a dispersant. The dispersant comprises a resin affinity segment A and a cellulose affinity segment B and has a block copolymer structure or a gradient copolymer structure.

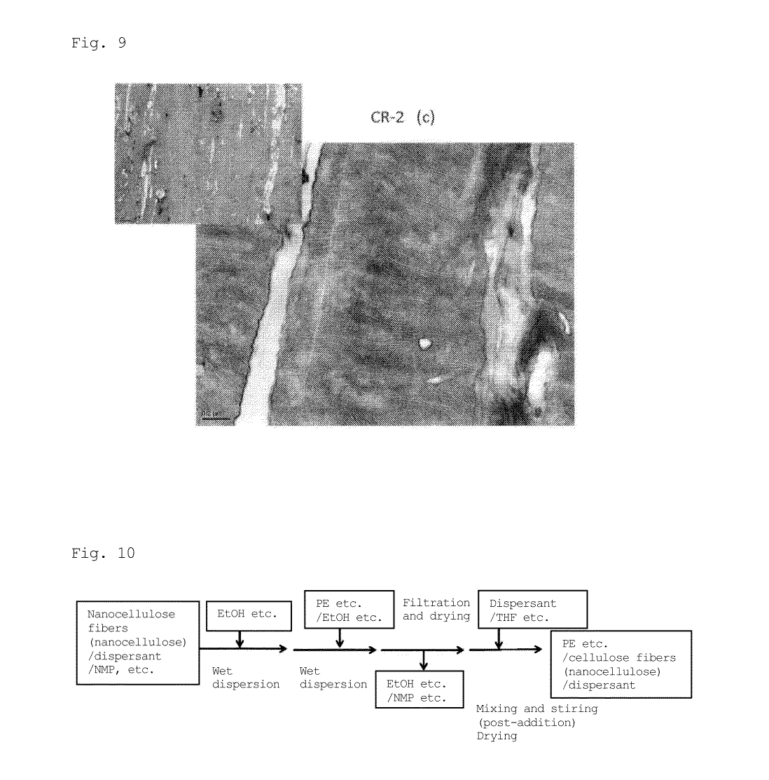

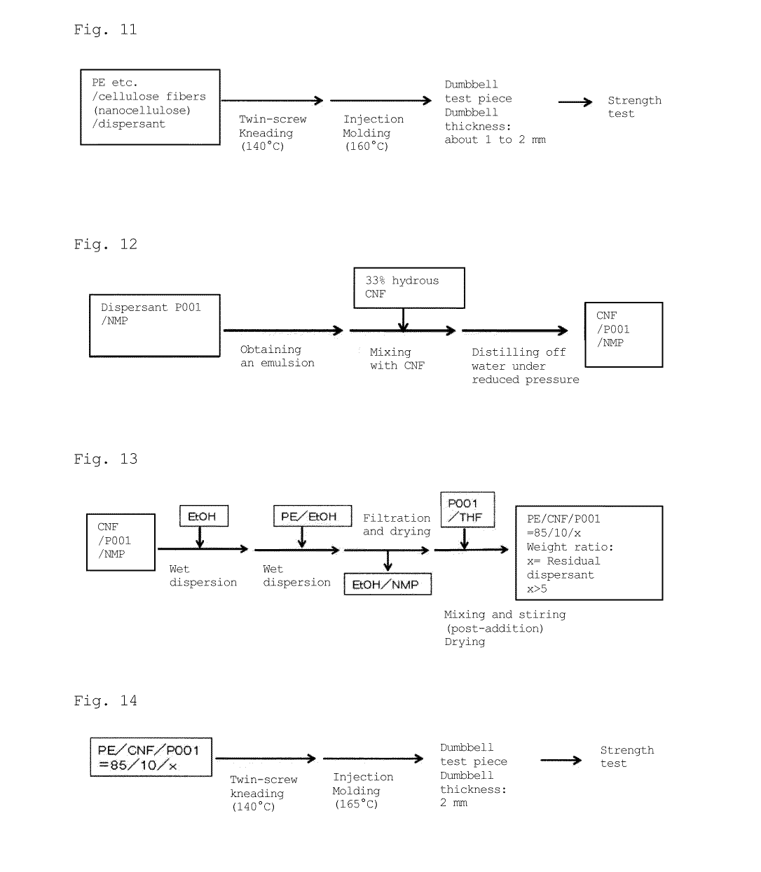

The resin composite composition of the present invention comprises cellulose and a resin. The resin composite composition is structured such that lamellae of the resin are formed in the composition and layered in a direction different from the fiber length direction of the cellulose (FIGS. 7 to 9).

The resin composite composition comprises fibrous cores of the resin that are uniaxially oriented in the fiber length direction of cellulose, wherein the lamellae of the resin are layered between the cellulose and the fibrous cores in a direction different from the fiber length direction of the cellulose.

The formation of lamellae of the resin component in the resin composition is believed to increase the strength of the resin composition.

The above structure is described as a shish kebab structure (shish kabab structure) formed by a combination of cellulose and a resin. The structure is so named because it resembles Turkish, skewered roasted meat (“shish” is skewer, and “kebab” is meat).

In the shish kebab structure according to the present invention, the shish part is the extensile fibers of the cellulose, and the kebab part is the lamellae of the resin (lamellar crystals, folded configuration). Because of the shish kebab structure formed by cellulose and a resin, the resin composition (molding material, molded article) has a higher tensile strength and elastic modulus.

### (5) Method for Producing a Resin Composite Composition Comprising Cellulose, a Resin, and a Dispersant

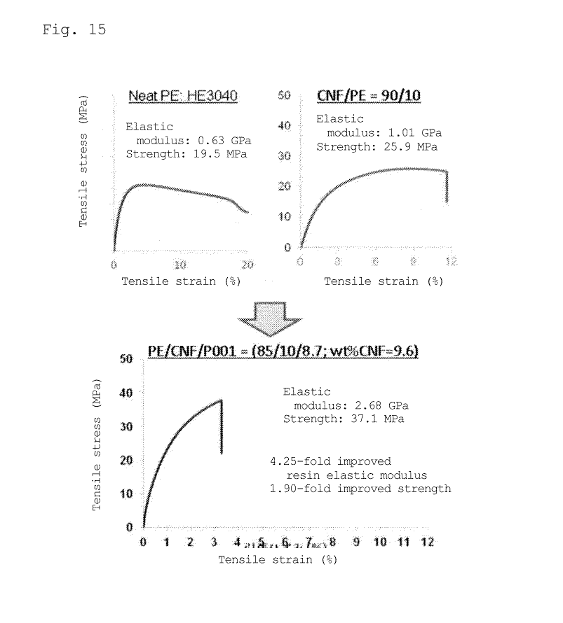

The following describes a specific method for producing a resin composite composition of the present invention (FIG. 10).

### Production Method 1

A method for producing a resin composite composition, the method comprising the steps of:

(1) mixing cellulose and a dispersant to obtain a composition comprising the cellulose and the dispersant; and

(2) mixing a resin and the composition obtained in step (1),

wherein the dispersant comprises a resin affinity segment A and a cellulose affinity segment B and has a block copolymer structure or a gradient copolymer structure.

The dispersant is first mixed with cellulose in step (1); thus, when the composition obtained in step (1) is mixed with a resin in step (2), the aggregation of cellulose is prevented, and the dispersibility of cellulose is improved, making it possible to improve the properties of the resin composite composition.

### Production Method 2

A method for producing a resin composite composition, the method comprising the steps of:

(1) mixing cellulose and a dispersant to obtain a composition comprising the cellulose and the dispersant; and

(2) mixing a resin, a dispersant, and the composition obtained in step (1),

wherein the dispersant comprises a resin affinity segment A and a cellulose affinity segment B and has a block copolymer structure or a gradient copolymer structure.

The dispersant is first mixed with cellulose in step (1); thus, when the composition obtained in step (1) is mixed with a resin in step (2), the aggregation of cellulose is prevented, and the dispersibility of cellulose is improved.

The amount of the dispersant may be increased or adjusted at the time of mixing with a resin in accordance with the type of the cellulose and the resin used, to thereby improve the properties of the resin composite composition.

### Production Method 3

A method for producing a resin composite composition, the method comprising the steps of:

(1) mixing cellulose and a dispersant to obtain a composition comprising the cellulose and the dispersant;

(2) mixing a resin and a dispersant to obtain a resin composition comprising the resin and the dispersant; and

(3) mixing the composition obtained in step (1) and the resin composition obtained in step (2),

wherein the dispersant comprises a resin affinity segment A and a cellulose affinity segment B and has a block copolymer structure or a gradient copolymer structure.

The dispersant is first mixed with cellulose in step (1); thus, when the resin composite composition is produced in step (3), the aggregation of cellulose is prevented, and the dispersibility of cellulose is improved.

The dispersant may be mixed with the resin to be used in step (3) in advance, and the amount of the dispersant may be adjusted to contribute to improvement in the properties of the resin composite composition. Further, when the additional amount of the dispersant is predetermined, the additional amount of the dispersant may be mixed with the resin in advance to simplify the process.

### Production Method 4

A method for producing a resin composite composition, the method comprising the steps of:

(1) mixing cellulose and a dispersant to obtain a composition comprising the cellulose and the dispersant;

(2) mixing a resin and a dispersant to obtain a resin composition comprising the resin and the dispersant; and

(3) mixing the composition obtained in step (1), the resin composition obtained in step (2), and a resin,

wherein the dispersant comprises a resin affinity segment A and a cellulose affinity segment B and has a block copolymer structure or a gradient copolymer structure.

Depending on the type of the resin used, it may be effective to mix the resin with a large amount the dispersant in step (2). In such a case, the resin may be additionally used in step (3) to adjust and optimize the composition of the resin composite composition, so as to improve the properties of the resin composite composition.

### Production Method 5

A method for producing a resin composite composition, the method comprising the steps of:

(1) mixing cellulose and a dispersant to obtain a composition comprising the cellulose and the dispersant;

(2) mixing a resin and a dispersant to obtain a resin composition comprising the resin and the dispersant; and

(3) mixing the composition obtained in step (1), the resin composition obtained in step (2), and a dispersant,

wherein the dispersant comprises a resin affinity segment A and a cellulose affinity segment B and has a block copolymer structure or a gradient copolymer structure.

Depending on the type of the resin used, it may be effective to mix the resin with a small amount of the dispersant in step (2). In such a case, the dispersant is additionally used in step (3) to adjust and optimize the composition of the resin composite composition, so as to improve the properties of the resin composite composition.

### Production Method 6

The method for producing a resin composite composition, the method comprising the steps of:

(1) mixing cellulose and a dispersant to obtain a composition comprising the cellulose and the dispersant;

(2) mixing a resin and a dispersant to obtain a resin composition comprising the resin and the dispersant;

(3) mixing the composition obtained in step (1), the resin composition obtained in step (2), a resin, and a dispersant,

wherein the dispersant comprises a resin affinity segment A and a cellulose affinity segment B and has a block copolymer structure or a gradient copolymer structure.

The composition of the cellulose, the dispersant, and the resin used in step (1) and step (2) may not be optimal, depending on the type of the cellulose and the resin used, to achieve the characteristics of the resin composite composition produced in step (3).

In this case, suitable amounts of the resin and the dispersant may be added in step (3) to adjust and optimize the composition of the resin composite composition to be produced, so as to improve the properties of the resin composite composition.

### Production Method 7

A method for producing a resin composite composition, the method comprising the step of

(1) mixing cellulose, a resin, and a dispersant to obtain a resin composite composition,

wherein the dispersant comprises a resin affinity segment A and a cellulose affinity segment B and has a block copolymer structure or a gradient copolymer structure.

When the cellulose is mixed with the resin in the presence of the dispersant, they are better blended, and the dispersibility of cellulose is improved, depending on the type of the cellulose and the resin used, thus achieving improvement in the characteristics of the resin composite composition.

### Production Method 8

A method for producing a resin composite composition, the method comprising the steps of:

(1) mixing a resin and a dispersant to obtain a resin composition comprising the resin and the dispersant; and

(2) mixing cellulose and the resin composition obtained in step (1),

wherein the dispersant comprises a resin affinity segment A and a cellulose affinity segment B and has a block copolymer structure or a gradient copolymer structure.

When a modified resin to which the dispersant has been added in advance is used, the cellulose and the resin are better blended, and the dispersibility of cellulose is improved, depending on the type of the cellulose and the resin used, thus achieving improvement in the characteristics of the resin composite composition.

### Production Method 9

A method for producing a resin composite composition, the method comprising the steps of:

(1) mixing a resin and a dispersant to obtain a resin composition comprising the resin and the dispersant; and

(2) mixing cellulose, a resin, and the resin composition obtained in (1),

wherein the dispersant comprises a resin affinity segment A and a cellulose affinity segment B and has a block copolymer structure or a gradient copolymer structure.

When a modified resin to which the dispersant has been added in advance is used, the cellulose and the resin are better blended, and the dispersibility of cellulose is improved, depending on the type of the cellulose and the resin used. Further, the addition of the resin in step (2) will improve the properties of the composite resin composition with the use of a minimum required amount of the dispersant.

### Production Method 10

A method for producing a resin composite composition, the method comprising the steps of:

(1) mixing a resin and a dispersant to obtain a resin composition comprising the resin and the dispersant; and

(2) mixing cellulose, a dispersant, and the resin composition obtained in step (1),

wherein the dispersant comprises a resin affinity segment A and a cellulose affinity segment B and has a block copolymer structure or a gradient copolymer structure.

When a modified resin to which the dispersant has been added in advance is used, the cellulose and the resin are better blended, and the dispersibility of cellulose is improved, depending on the type of the cellulose and the resin used. Further, the additional use of the dispersant in step (2) will, for example, strengthen the interface, thus improving the properties of the composite resin composition.

### Production Method 11

A method for producing a resin composite composition, the method comprising the steps of:

(1) mixing a resin and a dispersant to obtain a resin composition comprising the resin and the dispersant; and

(2) mixing cellulose, a resin, a dispersant, and the resin composition obtained in step (1),

wherein the dispersant comprises a resin affinity segment A and a cellulose affinity segment B and has a block copolymer structure or a gradient copolymer structure.

When a modified resin to which the dispersant has been added in advance is used, the cellulose and the resin are better blended, and the dispersibility of cellulose is improved, depending on the types of the cellulose and the resin used. Additionally, in step (2), the amounts of the dispersant and the resin may be easily optimized in accordance with the type of the cellulose used, so as to make an attempt to improve the properties of the composite resin composition.

### Production Method 12

A method for producing a resin composite composition,

the method comprising further mixing a resin with the resin composite composition obtained by using the production method of any one of the production methods 1 to 11,

wherein the dispersant comprises a resin affinity segment A and a cellulose affinity segment B and has a block copolymer structure or a gradient copolymer structure.

When the resin composite composition produced in advance is diluted with a resin of the same or a different kind, the physical properties of the composite composition is easily adjusted within a broad range.

Further, when the resin composite composition produced in advance comprises a higher proportion of cellulose, the dispersibility of cellulose is expected to be improved, and additionally, the cellulose concentration is effectively adjusted to the level in the final resin composite composition.

In each step, the components described above may be used, i.e., the cellulose, dispersant, and resin. The amounts of the cellulose, the dispersant, the resin, and the like, such as the amount of the dispersant relative to cellulose and the amount of cellulose relative to the resin component may be adjusted as stated above.

The resin composite composition (composite material) may be prepared by mixing cellulose with a resin using a dispersant. The cellulose affinity segment B of the dispersant and the functional groups of cellulose may react, for example, to form chemical bond. All of, or a portion of, the functional groups in the cellulose may react with the cellulose affinity segment B of the dispersant.

Examples of methods for mixing cellulose with a resin component (optionally with an additive) include kneading methods using a mixer, such as a bench roll, a Banbury mixer, a kneader, and a planetary mixer; mixing methods using an agitating blade; and mixing methods using a revolving or rotating agitator.

The temperature for mixing is not particularly limited. The cellulose may be mixed with the resin component at room temperature without heating or with heating. When mixing is performed with heating, the mixing temperature is preferably about 40° C. or more, more preferably about 50° C. or more, and still more preferably about 60° C. or more.

At the mixing temperature of about 40° C. or more, the cellulose may be uniformly mixed with the resin component while allowing the dispersant to react with the cellulose.

The resin composite composition (composite material) of the present invention is prepared by mixing cellulose with a resin using a dispersant. Therefore, the cellulose and the resin in the resin composition are easily mixed. In traditionally used resin compositions, highly hydrophilic cellulose mixes poorly with highly hydrophobic plastic resin (e.g., PP and PE).

In the resin composition of the present invention, cellulose is excellently dispersed in the resin (dispersion medium). The molding materials, or molded articles produced by using the resin composition, have high strength and elastic modulus.

### (6) Resin Molding Material and Resin Molded Article

In the resin composition (molding material or molded article) produced by the above production method, nanocellulose is satisfactorily dispersed in the resin, thus achieving improved tensile strength and a high elastic modulus.

Further, cellulose and a resin can form a shish kebab structure. The extensile fibers of cellulose correspond to the shish part, and the lamellae (lamellar crystals, folded configuration) of the resin correspond to the kebab part. Accordingly, the resin composition of the present invention achieves synergistically improved tensile strength and elastic modulus.

The resin molding material of the present invention comprises the resin composite composition.

The resin molded article of the present invention is obtained by molding the resin molding material.

The composition of the present invention may be used to combine cellulose and a resin to produce a molding material, and from the molding material, a molded article (molded product) may be produced.

The molded article that contains cellulose and a resin and that is obtained by using the composition of the present invention has a higher tensile strength and elastic modulus than molded articles containing only a resin, or molded articles obtained by combining cellulose with a resin without using the composition of the present invention.

The present invention enables preparation of a resin molding material by using the composition, resin composition, and resin composite composition (FIG. 11) described above.

The composition, resin composition, and resin composite composition may be molded into a desired shape and used as a molding material. The molding material may be, for example, in the form of sheets, pellets, and powder. Molding materials in such shapes may be obtained by using a technique such as compression molding, injection molding, extrusion molding, hollow molding, and foam molding.

According to the present invention, the molding material may be molded into a molded article. The molding conditions for resin can be suitably adjusted to be applied to the molding of the molding material as necessary. The molded article according to the present invention can be used not only in the field of fiber-reinforced plastics where nanocellulose-containing resin molded articles are used but also in fields where higher mechanical strength (e.g., tensile strength) is required.

The molded article can be effectively used, for example, in interior materials, exterior materials, and structural materials of automobiles, electric trains, marine vessels, and airplanes; cases, structural materials, and inner parts of electric appliances, such as personal computers, televisions, telephones, and clocks; cases, structural materials, and inner parts of mobile communication equipment such as mobile phones; cases, structural materials, and inner parts of portable music reproduction equipment, image reproduction equipment, printing equipment, copy machines, and sporting goods; building materials; and business equipment, cases, and containers, such as stationery.

### EXAMPLES

Below, Examples and Comparative Examples describe the present invention in more detail. However, the invention is not limited to these Examples.

### Examples

### 1. Dispersant (Block Copolymer)

### (1) Block Copolymer P001

Monomers (DCPOEMA) for constituting the resin affinity segment (chain A) were dissolved in an amphiphilic solvent (e.g., propylene glycol or monopropyl ether) and subjected to a living radical polymerization in the presence of a catalyst. After a predetermined duration of time, monomers (e.g., HEMA) for constituting the cellulose affinity segment B were added thereto to synthesize a block copolymer. The prepared block copolymer was added dropwise to hydrous methanol to obtain a precipitate as a solid. The catalyst and monomer residues were removed.

### 2. Preparation of Cellulose (Nanocellulose (CNF))

600 g of softwood bleached kraft pulp (NBKP, refiner-treated, Oji Paper Co., Ltd., solids content: 25%) was added to 19.94 kg of water to prepare an aqueous suspension (an aqueous suspension having a pulp slurry concentration of 0.75% by weight).

The obtained slurry was mechanically defibrated using a bead mill (NVM-2, manufactured by Aimex Co., Ltd.) (zirconia bead diameter: 1 mm, loading amount of beads: 70%, engine speed: 2,000 rpm, and processing cycles: 2). After the defibration treatment, dehydration was performed using a filter press.

### 3. Production of Cellulose-Fiber-Resin Molded Article Using a Dispersant (Block Copolymer)

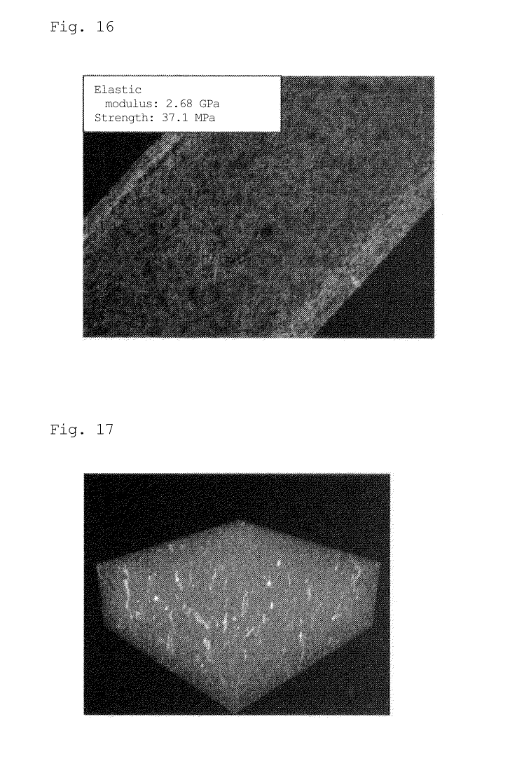

### (1) Method for Preparing a CNF/P001/NMP Dispersion Liquid (FIG. 12)

NMP (N-methylpyrrolidone) was added to hydrous CNF so that the water/NMP ratio became optimal (1/1 when P001 was used), and a block copolymer (dispersant) emulsion (the water/NMP ratio was dependent on the dispersant: 1/1 when P001 was used) was added thereto (pre-addition) and mixed.

After a predetermined duration of time, water was distilled off by heating (80° C.) under reduced pressure, or water and NMP were removed by filtration and pressing, to thereby prepare dispersion liquids (CNF/P001/NMP and CNF/P001/NMP/water).

### (2) Method for Preparing a PE/CNF/P001 Resin Composition (FIG. 13)

The CNF/P001/NMP obtained in (1) above was dispersed in a protonic organic solvent (ethanol (EtOH)) and filtered. The unadsorbed dispersant was quantified by gel-permeation chromatography or the like.

The resulting product was dispersed again in a protonic organic solvent, and polyethylene (PE) resins (HE3040 and J320) were added thereto and mixed. After the solvent was removed by filtration, a THF solution of the block copolymer (dispersant) P001 was added (post-addition) and mixed, followed by removal of the organic solvent by drying under reduced pressure. A PE/CNF/P001 resin composition was thereby obtained.

### Mixing Conditions

Kneader: TWX-15 manufactured by Technovel Corporation
Kneading Conditions: Temperature: 140° C.
   Discharge: 600 g/H
   Screw rotation speed: 200 rpm

### (3) Preparation of PE/CNF/P001 Molded Article (FIG. 14)

The PE/CNF/P001 resin composition obtained in (2) above was kneaded (at 140° C. when PE was used, and at 180° C. when PP was used) with a twin-screw extruder, and then, a molded article was produced by injection molding (at 160° C. when PE was used, and at 190° C. when PP was used).

### Injection Molding Conditions

Injection Molding Machine: NP7 manufactured by Nissei Plastic Industrial Co., Ltd.
Molding Conditions:
   Molding Temperature: 160° C. (when PE was used) or 190° C. (when PP was used)
   Mold Tool Temperature: 40° C.
   Injection Rate: 50 cm³/second

### Alternatively,

Simplified Injection Molding Machine: IMC-18D1 manufactured by Imoto machinery Co., Ltd.
Molding Conditions: Molding Temperature: 165° C. (when PE was used)

The elastic modulus and tensile strength of each of the obtained specimens were measured by using an electromechanical universal testing machine (manufactured by Instron) at a testing rate of 1.5 mm/min (load cell 5 kN). The support span was 4.5 cm.

FIG. 15 is graphs showing the evaluation results of the tensile strain of a cellulose fiber (CNF)-resin (PE) molded article obtained using the block copolymer (P001) of the present invention.

FIG. 16 is a polarizing microscope image of a cellulose-fiber-resin molded article obtained using the block copolymer (P001) of the present invention. FIG. 17 is an analytical image obtained from an X-ray CT scanner. It is a block copolymer (polymer dispersant)-coated CNF-PE molded article. The block copolymer (polymer dispersant)-coated CNF-PE molded article achieved less orientation and contained less aggregation of CNF.

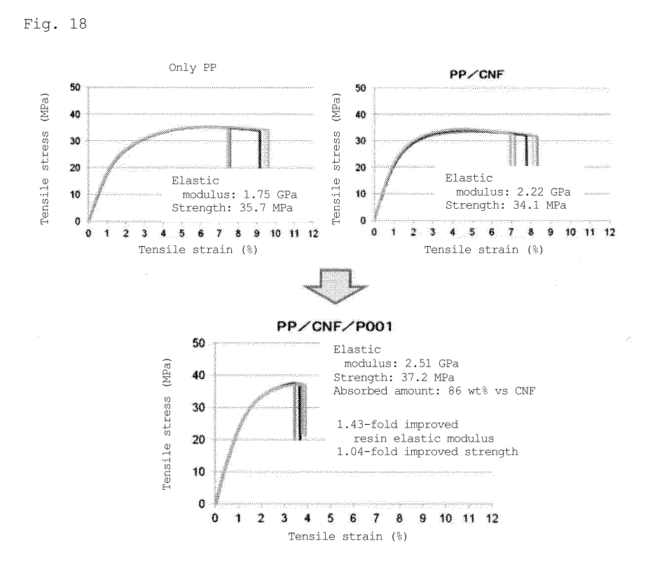

FIG. 18 is graphs showing the evaluation results of the tensile strain of a cellulose fiber (CNF)-resin (PP) molded article obtained using the block copolymer (P001) of the present invention. Even with a PP resin, the block copolymer improved the dispersibility of cellulose fibers (CNF). It was thereby found that the block copolymer of the present invention serves as a dispersant for dispersing cellulose fibers (CNF) in a PP resin.

Trimix drying is applicable in the process for producing a cellulose fiber (CNF)-resin (PE) molded article (PE/CNF/P001 molded article) by using the block copolymer (P001) of the present invention.

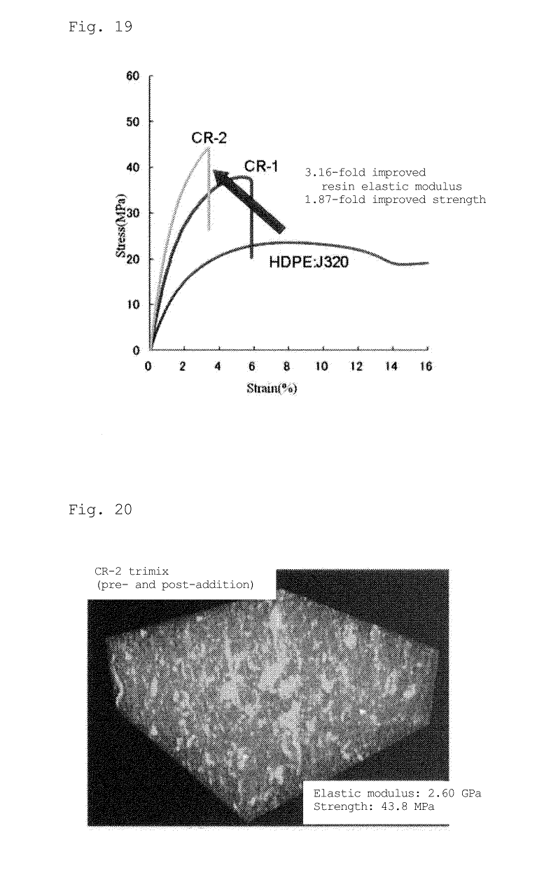

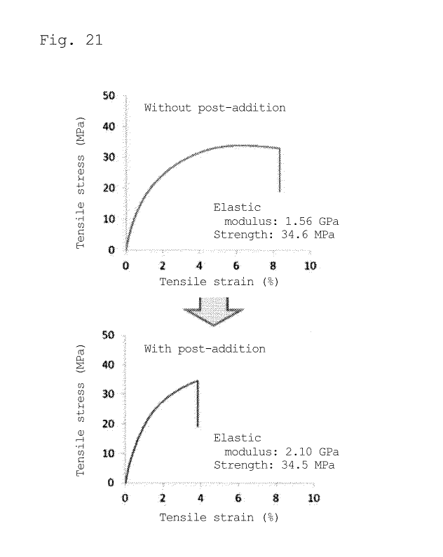

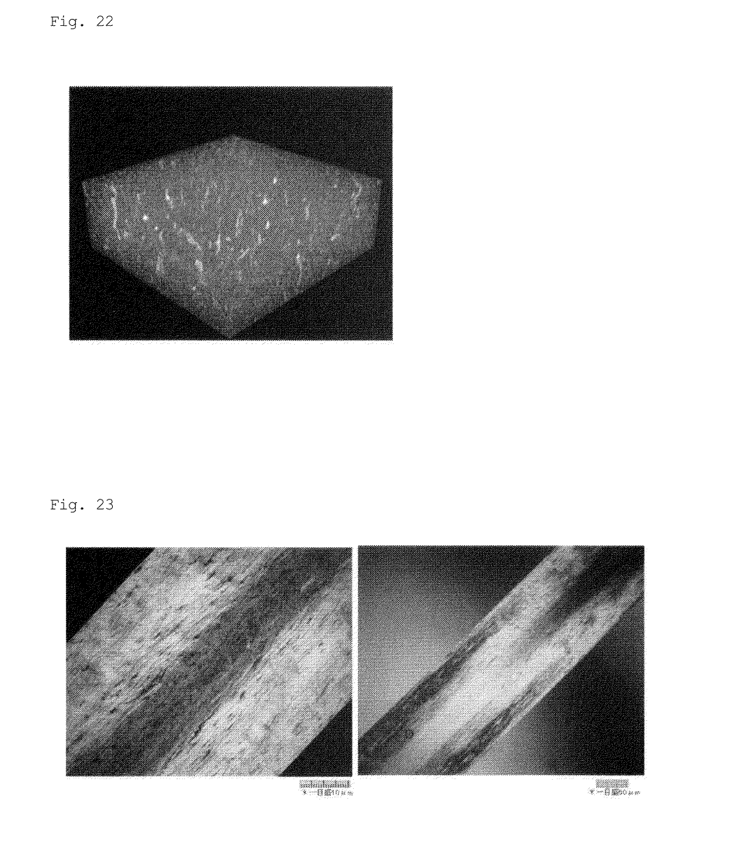

Table 4 and FIG. 19 show the evaluation results of the use of trimix drying in the process for producing a cellulose fiber (CNF)-resin (PE) molded article (PE/CNF/P001 molded article). FIG. 20 is an analytical image of a cellulose-fiber-resin molded article and is obtained from an X-ray CT scanner.

The molded articles CR-1 and CR-2 shown in Table 4 were obtained by using a trimix dryer (dried under reduced pressure with stirring) in the production process. The molded article of HDPE (high-density polyethylene) is free from a dispersant and CNF; thus, the article obtained by injection molding the resin was evaluated, regardless of drying.

Although the aggregation of CNF was observed, excellent mechanical properties were confirmed.

CR-1 was obtained only by pre-addition. The results of CR-2 can be compared with FIG. 15.

TABLE 4

| Tensile | | | |
|---|---|---|---|
| characteristics | HDPE: J320 | CR-1 | CR-2 |
| Elastic modulus | 0.82 | 1.79 | 2.60 |
| (GPa) | | | |
| Strength | 23.4 | 38.1 | 43.8 |
| (MPa) | | | |
| Extension rate | >100 | 5.14 | 2.95 |
| (%) | | | |

FIG. 21 is graphs showing the evaluation results of the production of a cellulose fiber (pulp raw material)-resin (PE) molded article obtained using the block copolymer of the present invention. It was found that the block copolymer of the present invention serves as a dispersant for dispersing a pulp raw material in, for example, a PE or PP resin.

When the block copolymer of the present invention is added to a mixture of a pulp raw material and a resin (e.g., PE or PP), the pulp raw material is expected to be defibrated to a nano level through a kneading step. After the block copolymer of the present invention is added to a pulp raw material, the pulp raw material can be defibrated to a nano level.

FIG. 22 is an analytical image of a cellulose fiber (CNF)-resin (PE) molded article obtained using the block copolymer (P001) of the present invention, the image being obtained from an X-ray CT scanner.

Although aggregation of CNF was observed, excellent mechanical properties were confirmed. The use of the block copolymer (dispersant) of the present invention made it possible to prevent aggregation of cellulose fibers (CNF) in the resin composition.

FIG. 23 are polarizing microscope observation images of a sample produced by trimix drying a cellulose fiber (CNF)-resin (PE) molded article obtained using the block copolymer (P001) of the present invention.

The polarizing microscope images show the orientation of resin in the resin composition. The use of the block copolymer (dispersant) of the present invention achieved strong orientation of the resin component (CR-2).

CR-2 achieved strong orientation. FIGS. 7 to 9 show TEM observation images in terms of (a), (b), and (c). CR-2 explicitly showed a shish kebab structure. The TEM images (FIGS. 7 to 9) show a shish kebab structure inside the cellulose-fiber-resin molded article.

The use of the block copolymer (dispersant) (CR-2) of the present invention produced a molded article with a highly developed shish kebab structure of PE. This shish kebab structure is assumed to contribute to improvement in the mechanical properties. FIGS. 7 to 9 show TEM observation images of the resin molded article (CNF-PE obtained using the block copolymer) of the Examples.

The observation revealed that the resin molded article of the Examples contains lamellae of PE, and the lamellae are regularly layered in a direction different from the fiber length direction of CNF.

Specifically, crystalline lamellae of PE were vertically grown from the surface of the CNF in the resin molded article of the Examples. Further, in the resin molded article of the Examples, fibrous cores of PE that were uniaxially oriented in the fiber length direction of the CNF were formed, and the lamellae of PE were layered between the CNF and the fibrous cores in a direction different from the fiber length direction of the CNF.

The combination of CNF and PE formed a shish kebab structure (shish kabab structure). In this shish kebab structure, the shish part is the extensile fibers of the CNF, and the kebab part is the lamellae of PE (lamellar crystals, folded configuration). The resin composition (molding material, molded article) having the shish kebab structure formed by CNF and PE achieved higher tensile strength and elastic modulus.

The lamellae formation is assumed to greatly contribute to increasing resin reinforcement.

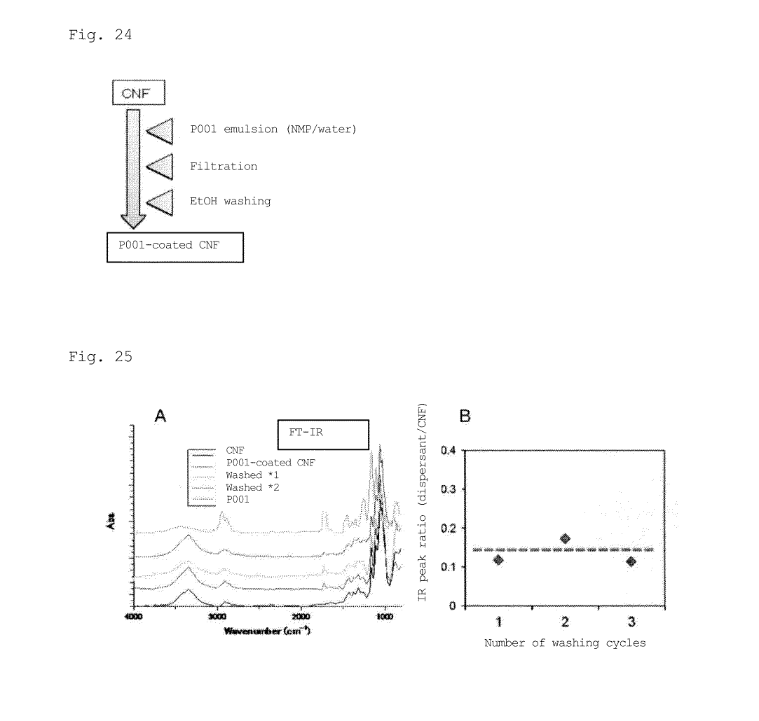

FIGS. 24 to 26 show the features of CNF coated with the block copolymer P001 (dispersant).

FIG. 24 is a flowchart of the method for preparing CNF coated with the block copolymer P001 (dispersant).

The FT-IR (FIG. 25A) indicates that the block copolymer (dispersant) would not be washed away from the CNF surface. FIG. 25B shows the results of the IR peak ratio relative to the number of washing cycles. Even after washing, the IR peak ratio stays constant, which indicates that almost no adsorbed dispersant was eluted with the solvent.

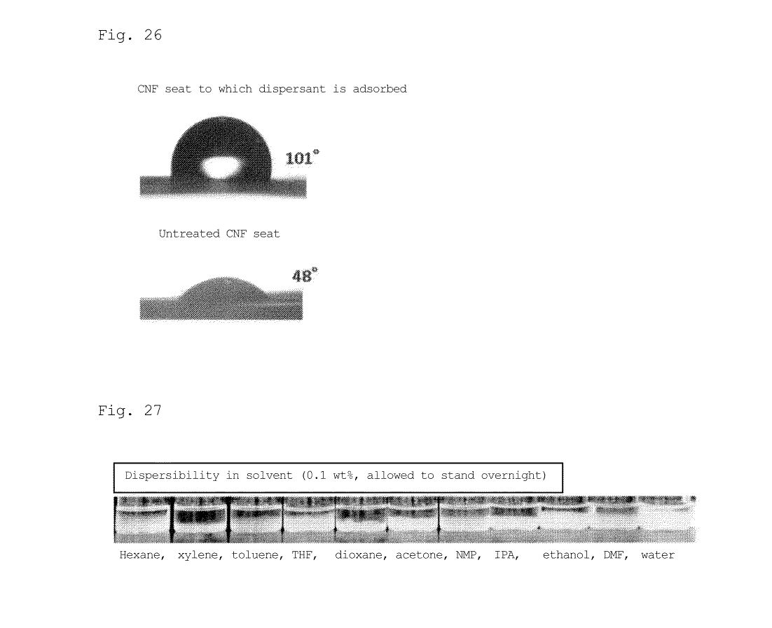

The contact angle measurement results (FIG. 26) indicate that the CNF coated with the block copolymer (dispersant) is sufficiently hydrophobic.

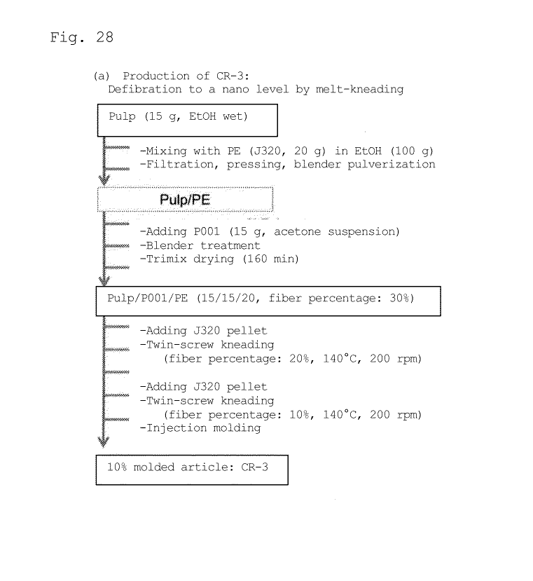

The photographs in relation to the dispersibility in organic solvents (FIG. 27) indicate that the CNF coated with the block copolymer (dispersant) can be dispersed in various solvents.

Tables 5 and 6 show the currently produced dispersants (block copolymers).

TABLE 5
Dispersant 1

| | | | | | | | | Entire | Entire |
|---|---|---|---|---|---|---|---|---|---|
| | | Number | Molecular | Number | | Number | Number | Number | Molecular |
| | | Average | Weight | average | | Average | average | Average | Weight |
| | | Molecular | Distribution | polymerization | Chain B | Molecular | polymerization | Molecular | Distribution |
| Code | Chain A | weight | Index | degree | Main | Weight | degree | Weight | Index |
| name | monomer | (Mn) | (Mw/Mn) | (DPn) | monomer | (Mn) | (DPn) | (Mn) | (Mw/Mn) |
| A001 | LMA | 10500 | 1.20 | 41 | MOI/MMA | 1700 | — | 12200 | 1.25 |
| C001 | LMA | 10000 | 1.20 | 39 | HEMA | 1300 | 10 | 11300 | 1.30 |
| C002 | LMA | 7800 | 1.31 | 31 | HEMA | 1700 | 13 | 9500 | 1.31 |
| C003 | LMA | 4900 | 1.28 | 19 | HEMA | 2200 | 17 | 7100 | 1.34 |
| G001 | tBCHMA | 8000 | 1.33 | 36 | HEMA | 2200 | 17 | 10200 | 1.39 |
| G002 | tBCHMA | 5840 | 1.28 | 26 | HEMA | 2180 | 17 | 8020 | 1.37 |
| G002 | tBCHMA | 6030 | 1.33 | 27 | HEMA | 2270 | 17 | 8300 | 1.37 |
| G003 | tBCHMA | 4000 | 1.29 | 18 | HEMA | 2800 | 22 | 6800 | 1.35 |
| I001 | MMA | 3400 | 1.2 | * | HEMA | 2000 | 15 | 5400 | 1.28 |
| I002 | MMA | 6610 | 1.35 | 66 | HEMA | 2450 | 19 | 9060 | 1.37 |
| J001 | LMA | 6000 | 1.2 | * | MAA | 1300 | 15 | 7535 | 1.31 |
| K001 | CHMA | 4620 | 1.31 | 28 | HEMA | 2190 | 17 | 6810 | 1.35 |
| L001 | tBCHMA | 5930 | 1.36 | 26 | MOI/MMA | 2270 | — | 8200 | 1.6 |
| | | | | | (50.5/32.5) | | | | |

TABLE 6
Dispersant 2

| | | | | | | | | Entire | Entire |
|---|---|---|---|---|---|---|---|---|---|
| | | Number | Molecular | Number | | Number | Number | Number | Molecular |
| | | Average | Weight | Average | | Average | Average | Average | Weight |
| | | Molecular | Distribution | Polymerization | Chain B | Molecular | Polymerization | Molecular | Distribution |
| Code | Chain A | Weight | Index | Degree | main | Weight | Degree | Weight | Index |
| name | monomer | (Mn) | (Mw/Mn) | (DPn) | monomer | (Mn) | (DPn) | (Mn) | (Mw/Mn) |
| M001 | tBCHMA | 5830 | 1.36 | 26 | MPE/MMA | 2300 | — | 8130 | 1.54 |
| | | | | | (61.5/24.8/13.7) | | | | |
| N001 | IBOMA | 4220 | 1.38 | 19 | HEMA | 2310 | 18 | 6530 | 1.52 |
| N002 | IBOMA | 2380 | 1.19 | 11 | HEMA | 2100 | 16 | 4480 | 1.42 |
| P001 | DCPOEMA | 4710 | 1.42 | 18 | HEMA | 2470 | 19 | 7180 | 1.53 |
| P002 | DCPOEMA | 3540 | 1.29 | 14 | HEMA | 3780 | 29 | 7320 | 1.51 |
| P003 | DCPOEMA | 3300 | 1.33 | 13 | HEMA | 2100 | 16 | 5400 | 1.43 |
| P004 | DCPOEMA | 6730 | 1.43 | 26 | HEMA | 3260 | 25 | 9990 | 1.58 |
| Q001 | DCPMA | 4050 | 1.43 | 17 | HEMA | 2350 | 18 | 6400 | 1.48 |
| O002 | CHMA | 4820 | 1.52 | 29 | MAm/HEMA | 1000 | — | 5820 | 1.55 |
| R001 | LMA | 6040 | 1.31 | 24 | MOI/MMA | 1980 | — | 8020 | 1.35 |
| | | | | | (38.1/58.3) | | | | |
| T001 | DCPOEMA | 5740 | 1.42 | 22 | QDEMAEMA | 2000 | 7 | 7740 | 1.48 |

### (4) Experiment

The following three items were evaluated with regard to the production using pulp as a raw material. The most excellent mechanical properties were achieved in (c).

### (a) Defibration to a Nano Level by Melt-Kneading

### Sample CR-3

Ethanol-substituted pulp and an acetone suspension of dispersant P001 were mixed and trimix-dried, followed by melt-kneading (defibration to a nano level) at a fiber percentage of 20% with resin pellets (J320). The resulting product was then diluted with a resin, and molding was performed.

FIG. 28 shows the details of defibration to a nano level by melt-kneading (production of CR-3).

### (b) Defibration to a Nano Level by Kneading at a Low Temperature in Water

### Sample CR-4

Pulp, PE, a dispersant, and water (fiber percentage: 9%) were kneaded at a low temperature (difibration to a nano level). The resulting product was then mixed with a resin and melt-knead at a fiber percentage of 10%. Thereafter, molding was performed.

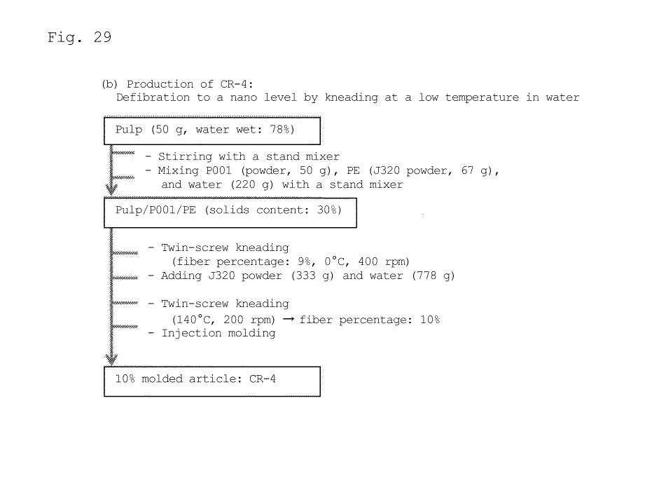

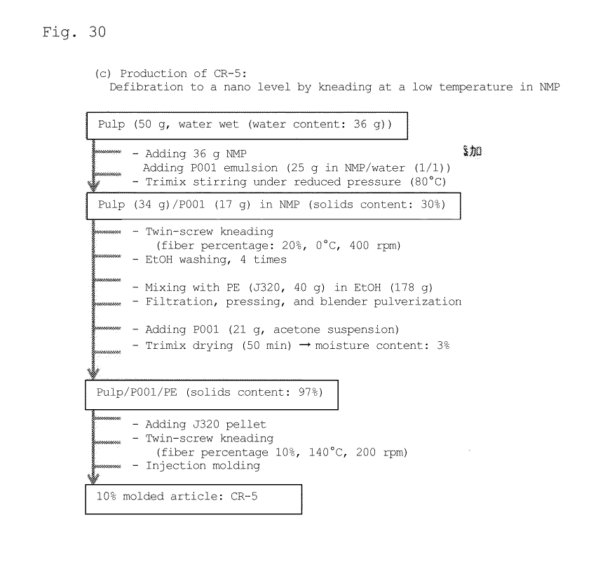

FIG. 29 shows the details of defibration to a nano level by kneading at a low temperature in water (production of CR-4).

### (c) Defibration to a Nano Level by Kneading at a Low Temperature in NMP

### Sample CR-5

Pulp and a dispersant emulsion were trimix-dried to prepare a dehydrated NMP suspension, which was kneaded at a low temperature at a fiber percentage of 20%. After NMP was removed with ethanol, the resulting product was mixed with a resin and trimix-dried to obtain a 30% master batch. The obtained master batch was diluted with a resin and melt-kneaded at a fiber percentage of 10%, and molding was performed.

FIG. 30 shows the details of the defibration to a nano level by kneading at a low temperature in NMP (production of CR-5).

The production using pulp achieved 3.6-fold improved resin elastic modulus and 2.3-fold improved strength.

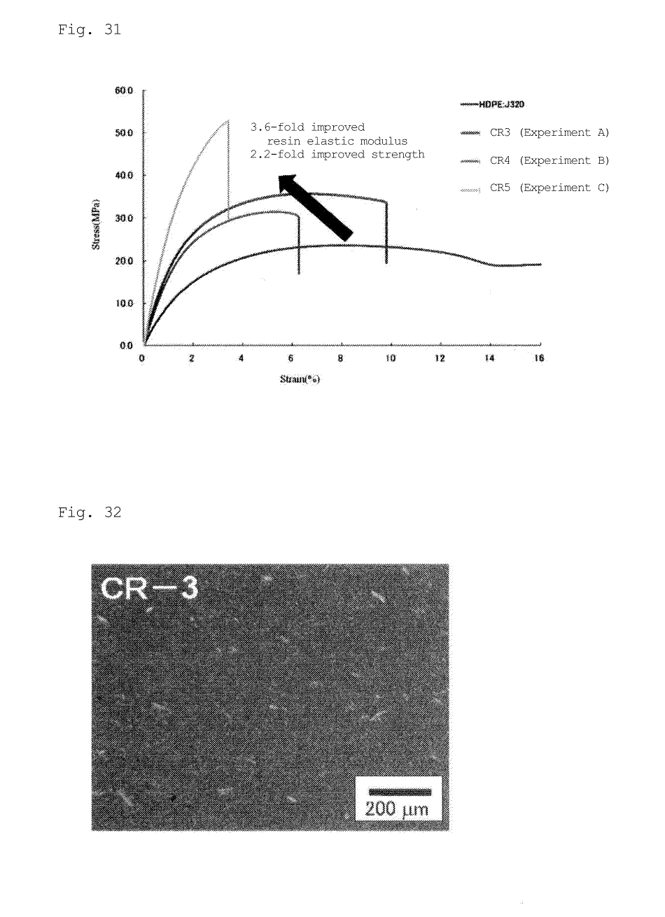

Table 7 and FIG. 31 show the results.

TABLE 7

| Tensile | HDPE: | Experiment | Experiment | Experiment |
|---|---|---|---|---|
| characteristics | J320 | (a) CR-3 | (b) CR-4 | (c) CR-5 |
| Elastic modulus | 0.82 | 1.64 | 1.60 | 2.96 |
| (GPa) | | | | |
| Strength | 23.4 | 35.6 | 31.4 | 52.6 |
| (MPa) | | | | |
| Extension rate | >100 | 8.31 | 5.51 | 3.33 |
| (%) | | | | |

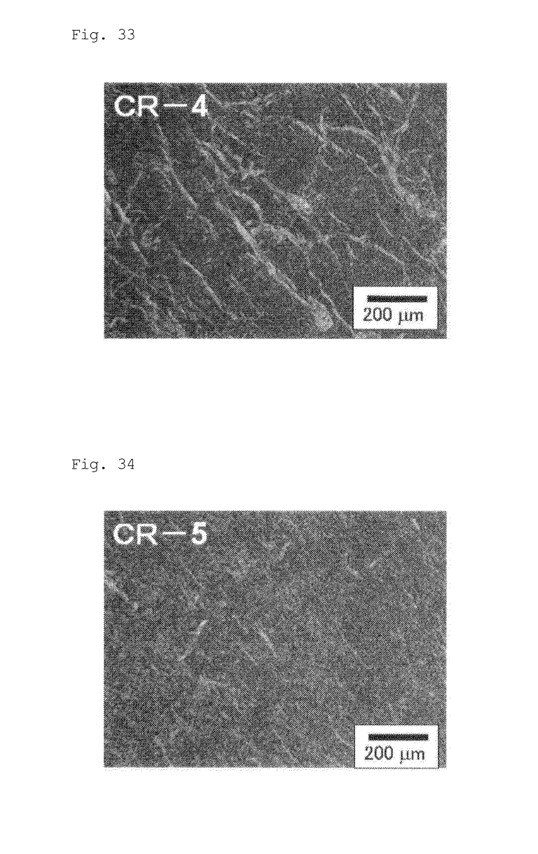

FIGS. 32 to 34 show observation images of pulp fibers obtained by hot-pressing dumbbell test pieces.

Almost no pulp was observed in CR-3, and it is believed that CNF was satisfactorily formed; however, it is presumed that fiber shortening occurred.

A large amount of pulp remained in CR-4, and defibration to a nano level was thus insufficient.

In CR-5, excellent formation of CNF was observed.

The production using pulp achieved 3.6-fold improved resin elastic modulus and 2.3-fold improved strength (FIG. 35 and Table 8).

TABLE 8

| | | HDPE + | HDPE + |
|---|---|---|---|
| Tensile | | CNF + | pulp + |
| characteristics | HDPE | dispersant | dispersant |
| Elastic modulus | 0.8 | 2.6 | 3.0 |
| (GPa) | | | |
| Strength | 23 | 44 | 53 |
| (MPa) | | | |

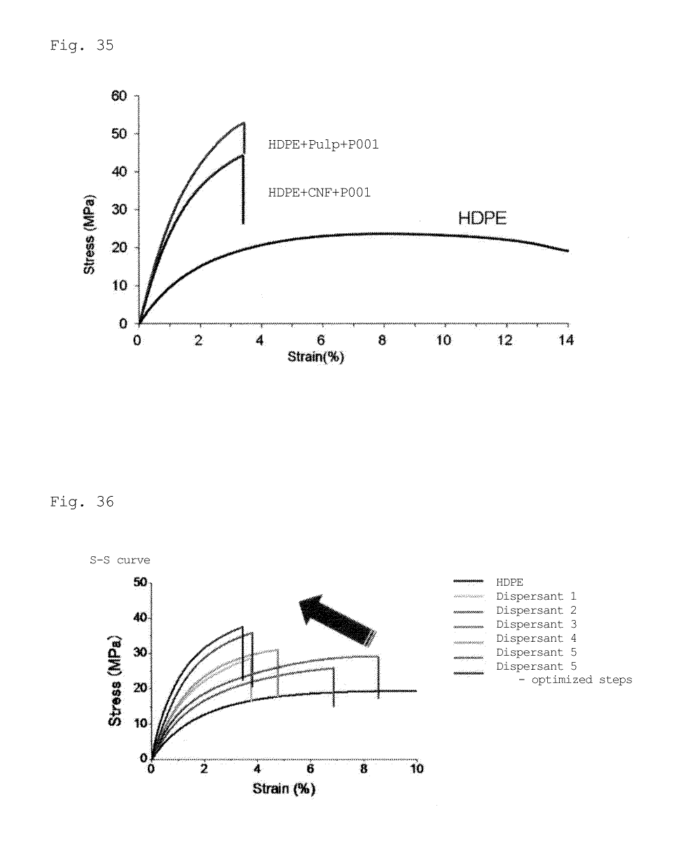

The use of the currently produced dispersant achieved the preparation of resin highly strengthened by CNF. The effect of the polymer dispersant was also seen in polypropylene (FIG. 36 and Table 9).

### Dispersant 1: G002

### Dispersant 2: N001

### Dispersant 3: O001

### Dispersant 4: Q001

### Dispersant 5: P001

TABLE 9

| Tensile | Elastic modulus | Strength |
|---|---|---|
| characteristics | (GPa) | (MPa) |
| HDPE | 0.63 | 19.5 |
| Dispersant 1 | 1.63 | 29.3 |
| Dispersant 2 | 1.05 | 28.8 |
| Dispersant 3 | 0.96 | 26.4 |
| Dispersant 4 | 1.57 | 30.7 |
| Dispersant 5 | 2.07 | 36.1 |
| Dispersant 5 + | 2.68 | 37.1 |
| optimized steps | | |

### Advantageous Effects of Invention

The typical type of the dispersant of the present invention is an A-B diblock copolymer or an A-B gradient copolymer comprising a resin affinity segment A (hydrophobic moiety, a cellulose fiber-dispersing segment) and a cellulose affinity segment B (hydrophilic moiety, a cellulose fiber-immobilizing segment). The dispersant is capable of modifying the surface of cellulose while maintaining the features of the cellulose fiber material. The use of the dispersant improves the dispersibility of cellulose fibers in resin. The dispersant can be used for dispersing cellulose fibers in resin.

When the composition comprising the dispersant of the present invention is used, the resin affinity segment A modifies the surface of highly hydrophilic cellulose via the cellulose affinity segment B. It is thereby possible to uniformly disperse cellulose fibers in a highly hydrophobic thermoplastic resin, particularly in polyethylene (PE) or polypropylene (PP). A cellulose-containing resin composite composition prepared using the dispersant achieves high compatibility between the cellulose and the resin, and high adhesion strength at the interface.

The composition comprising dispersant-coated cellulose and a wide variety of resin achieves excellent strength and elastic modulus. That is, it is possible to sufficiently achieve the reinforcement effect obtained by incorporating cellulose into resin, making it possible to improve tensile strength. It is possible to obtain a cellulosic resin composite material and a molded article with excellent strength, elastic modulus, heat resistance, and a linear thermal expansion coefficient as significantly low as an aluminum alloy.

The cellulose that is surface modified by the dispersant has a high reinforcement effect (tensile strength), in particular on PP, and adds high elastic modulus especially to PP, which is normally difficult to reinforce by known chemically modified cellulose fibers.

The dispersant contained in the composition of the present invention is preferably designed and synthesized by living radical polymerization (LRP). With the use of the dispersant, it is possible for cellulose to be mixed with and dispersed in an organic solvent or resin that have low affinity for cellulose under mild conditions of ordinary temperature and ordinary pressure.

Cellulose has hydroxyl groups on its surface and is thus effectively coated with the cellulose affinity segment B having an A-B diblock copolymer structure or an A-B gradient copolymer structure. The resin affinity segment A, which has an A-B diblock copolymer structure or an A-B gradient copolymer structure, hydrophobizes the cellulose surface. The hydrophobized cellulose is uniformly dispersed in a thermoplastic resin with very high hydrophobicity, such as PE or PP.

The resin affinity segment A, which has an A-B diblock copolymer structure or an A-B gradient copolymer structure, improves the strength at the interface between cellulose and a resin. It is thus possible to prevent aggregation of the cellulose in the resin, making it possible to obtain a composite material and molded article having excellent strength and a high elastic modulus.

The cellulose affinity segment B of the dispersant preferably contains hydroxyethyl methacrylate (HEMA). The resin affinity segment A of the dispersant preferably contains dicyclopentenyloxyethyl methacrylate (DCPOEMA).

It is preferable to add the dispersion as an emulsion to a water/NMP-based slurry containing cellulose. The use of the emulsion of dispersion at the time when cellulose fibers and a resin are mixed prevents the aggregation of the cellulose in the resin. Defibration of cellulose dispersed in resin to a nano level in the coexistence of the dispersant increases the strength of a resin composite composition (molding material, molded article).

The resin composite composition according to the present invention is regularly structured such that lamellae of the resin are formed in the resin composition, and layered in a direction different from the fiber length direction of the modified nanocellulose. Thus, molded articles formed of this resin composition have excellent mechanical strength.

The use of the composition comprising the dispersant of the present invention enables the production of a cellulose-fiber-resin composition-composite material having more excellent properties, e.g., higher strength, a higher elastic modulus, and a lower thermal expansion, compared with when known hydrophobizing modifiers of cellulose, dispersants of cellulose, and the like are used.

Moreover, the use of the composition comprising the dispersant of the present invention achieves satisfactory productivity of composite materials.

The composite material of the present invention has excellent tensile strength (elastic modulus) and heat resistance (TGA, HDT). To put it into practical use, easier production processes, reduced production process costs, and upscaled processes are expected.

The composite material of the present invention is effectively used as components for automobiles. The composite material of the present invention is also effectively used as structural materials, such as cases of electric appliances, such as televisions, telephones, and clocks; cases of mobile communication equipment such as mobile phones; and cases of printing equipment, copy machines, and sporting goods.

Further, the composite material of the present invention can invigorate industries involved with paper manufacturing companies that supply cellulose fibers, chemical companies that supply composite materials, and manufacturers that produce automobiles, home electrical appliances, information and communications, and sporting goods by using composite materials.

1. A composition comprising cellulose and the dispersant according to claim 10.

2. The composition according to claim 1,
wherein the cellulose is at least one member selected from the group consisting of cellulose nanofibers, microfibrillated cellulose, microcrystal cellulose, pulp, lignocellulose, and wood flour.

3. (canceled)

4. (canceled)

5. A resin composition comprising a resin and the dispersant according to claim 10.

6. The resin composition according to claim 5, wherein the resin is a thermoplastic resin.

7. A resin composite composition comprising cellulose, a resin, and the dispersant according to claim 10.

8. A resin molding material comprising the resin composite composition of claim 7.

9. A resin molded article obtained by molding the resin molding material of claim 8.

10. A dispersant comprising a resin affinity segment A and a cellulose affinity segment B and having a block copolymer structure or a gradient copolymer structure,
wherein the resin affinity segment A contains at least one monomer component selected from the group consisting of lauryl methacrylate (LMA), tert-butylcyclohexyl methacrylate (tBCHMA), cyclohexyl methacrylate (CHMA), methyl methacrylate (MMA), isobornyl methacrylate (IBOMA), dicyclopentenyloxyethyl methacrylate (DCPOEMA), dicyclopentanyl methacrylate (DCPMA), and styrene-based monomers,
wherein the cellulose affinity segment B contains at least one monomer component selected from the group consisting of hydroxyethyl methacrylate (HEMA), methacrylic acid (MAA), methacryl amide (MAm), benzylated dimethyl aminoethyl methacrylate (QDEMAEMA), 3-methacryloxypropyl triethoxysilane (MPE), methacryloyloxyethyl isocyanate (MOI), methacrylic acid glycidyl ester (GMA), methyl methacrylate (MMA), and styrene-based monomers,
with the proviso of excluding a combination of methacrylic acid (MAA) as the monomer component constituting the cellulose affinity segment B and any one of cyclohexyl methacrylate (CHMA), methyl methacrylate (MMA), or a styrene-based monomer, as the monomer component constituting the resin affinity segment A.

11. The dispersant according to claim 10,
wherein the resin affinity segment A has a number average molecular weight determined by gel permeation chromatography of 100 to 20,000 on a polystyrene basis, and the proportion of the resin affinity segment A in the entire dispersant is 5 to 95 mass %, and
wherein the cellulose affinity segment B has a number average molecular weight determined by gel permeation chromatography of 100 to 20,000 on a polystyrene basis, and the proportion of the cellulose affinity segment B in the entire dispersant is 5 to 95 mass %.

12. The dispersant according to claim 10,
wherein the dispersant has a number average molecular weight determined by gel permeation chromatography of 200 to 40,000 on a polystyrene basis, and a molecular weight distribution index (weight average molecular weight/number average molecular weight) of 1.0 to 1.6.

13. (canceled)

14. (canceled)

15. A method for producing a resin composite composition, the method comprising the steps of:
(1) mixing cellulose and the dispersant according to claim 10 to obtain a composition comprising the cellulose and the dispersant; and
(2) mixing a resin and the composition obtained in step (1).

16. A method for producing a resin composite composition, the method comprising the steps of:
(1) mixing cellulose and the dispersant according to claim 10 to obtain a composition comprising the cellulose and the dispersant; and
(2) mixing a resin, a dispersant, and the composition obtained in step (1).

17. A method for producing a resin composite composition, the method comprising the steps of:
(1) mixing cellulose and a dispersant to obtain a composition comprising the cellulose and the dispersant;
(2) mixing a resin and a dispersant to obtain a resin composition comprising the resin and the dispersant; and
(3) mixing the composition obtained in step (1) and the resin composition obtained in step (2),
wherein the dispersant comprises a resin affinity segment A and a cellulose affinity segment B and has a block copolymer structure or a gradient copolymer structure.

18. The method for producing a resin composite composition according to claim 17, the method further comprising the step of:
mixing a resin in step (3).

19. The method for producing a resin composite composition according to claim 17, the method further comprising the step of:
mixing a dispersant in step (3).

20. The method for producing a resin composite composition according to claim 17, the method further comprising the step of:
mixing a resin and a dispersant in step (3).

21. The method for producing a resin composite composition, the method comprising the step of
(1) mixing cellulose, a resin, and the dispersant according to claim 10 to obtain a resin composite composition.

22. A method for producing a resin composite composition, the method comprising the steps of:
(1) mixing a resin and a dispersant to obtain a resin composition comprising the resin and the dispersant; and
(2) mixing cellulose and the resin composition obtained in step (1),
wherein the dispersant comprises a resin affinity segment A and a cellulose affinity segment B and has a block copolymer structure or a gradient copolymer structure.

23. The method for producing a resin composite composition according to claim 22, the method further comprising the step of:
mixing a resin in step (2).

24. The method for producing a resin composite composition according to claim 22, the method further comprising the step of:
mixing a dispersant in step (2).

25. The method for producing a resin composite composition according to claim 22, the method further comprising the step of:
mixing a resin and a dispersant in step (2).

26. A method for producing a resin composite composition,
the method comprising further mixing a resin with the resin composite composition obtained by using the production method of claim 17.
